(19) United States
(12) Patent Application Publication
(10) Pub. No.: US 2012/0008921 A1
(43) Pub. Date: Jan. 12, 2012

(54) INFORMATION PROCESSING APPARATUS, INFORMATION PROCESSING METHOD, AND PROGRAM

(75) Inventors: Shinobu Hattori, Tokyo (JP); Kazuo Yamamoto, Chiba (JP); Motoki Kato, Kanagawa (JP); Yoshiyuki Kobayashi, Tokyo (JP); Kenjiro Ueda, Kanagawa (JP)

(73) Assignee: SONY CORPORATION, Tokyo (JP)

(21) Appl. No.: 13/170,780

(22) Filed: Jun. 28, 2011

(30) Foreign Application Priority Data
Jul. 8, 2010 (JP) P2010-155697

(51) Int. Cl. H04N 9/80

(52) U.S. Cl. 386/248; 386/E09.011

(57) ABSTRACT

An information processing apparatus includes a data processing unit which executes control of a copy process in which data recorded on a first medium is recorded on a second medium, and a data conversion unit which executes data conversion in the copy process, the data processing unit determines whether or not data to be copied recorded on the first medium is multi-angle content for which an angle change process is permitted, and when the data to be copied is determined to be multi-angle content, angle change point information is acquired and provided to the data conversion unit, and the data conversion unit creates converted data for which decoding is possible without referring to at least a preceding picture when the picture on an angle change point location is reproduced as a reproduction start point.

### BACKGROUND

The present disclosure relates to an information processing apparatus, an information processing method, and a program. Specifically, the disclosure further relates to an information processing apparatus, an information processing method, and a program for performing a process of executing conversion of predetermined data, generating converted copy data, and recording the data on a second medium when a process of copying data recorded on a medium (information recording medium) of a disc or the like is to be performed.

Recently, DVDs (Digital Versatile Discs), BDs (Blu-ray Discs (registered trademark)), and the like are frequently used as information recording media (media) of various forms of content including movies, music, and the like. Producers, distributors, or the like of most content including music data, image data, and the like recorded on these information recording media own the copyright or the distribution rights to the content. Therefore, even if a user purchases a disc, he or she is restricted to a certain degree in the use of the content recorded on the disc. For example, unlimited copying of the content recorded on the disc to another medium such as a disc, or the like is not permitted.

As a configuration of managing copying content stored in a media as above, a management configuration is known in which copying is permitted under a condition that copy permission information is obtained from a management server (MC: Managed Copy). The specific sequence of the managed copy (MC) is as follows.

A medium such as a content storing disc, or the like is loaded into a user device including a PC, a recording and reproducing device, or the like, and the user device is connected to the management server via a network.

After that, the user device transmits pre-defined information including a disc identifier (ID), or the like to the server.

The server verifies the authenticity of the received information, and then transmits copy permission information to the user device.

The user device starts a copy process with the condition that the copy permission information has been received from the server.

The copy process of the disc storing content to another medium is permitted as the sequence.

This copying management configuration is referred to as Managed Copy (MC), and detailed description thereof is disclosed in, for example, Japanese Unexamined Patent Application Publication No. 2008-98765.

On the other hand, there is the AACS (Advanced Access Content System) standard as a standard relating to a technology of protecting the copyright of content. Most content recorded on discs including BDs complying with the AACS standard is recorded as encrypted content. As a representative encryption configuration of the AACS standard, there is a configuration in which content is divided by units and different encryption keys are applied to the units. By adopting such an encryption configuration, it is possible to control the use of content by units, and to realize strict control of various content uses.

A unit into which content is divided is called a CPS unit, and an encryption key applied to an encryption process and a decryption process of each CPS unit is called a CPS unit key, a unit key, or a title key.

When content stored on a medium such as a BD storing movies or the like of which the copyright is the object to be managed is to be copied to another medium, for example, a hard disk, a flash memory, another disc, or the like in the user device as described above, copying is performed after receiving copy permission information from the management server in accordance with the above-described managed copy (MC).

However, if the content stored on a medium such as a BD is copied to, for example, a hard disk (HDD) that is a copy destination medium from one piece to another, free capacity of the hard disk with limited capacity decreases, and thereby it is not possible to record a large amount of content therein.

One method to solve such a problem is to perform compressed encoding of copy data, generate video data or audio data with higher compression rate, and then record the data on a copy destination in a copy process. Alternatively, the amount of data can be reduced by performing selective copying only of the necessary minimum data of images, audio components, subtitles, or the like without performing a process of lowering the bit-rate or copying the all of the data.

The process of performing compressed encoding and generating video data or audio data with a higher compression rate is performed by, for example, a transcoder which performs the conversion of encoded data. For example, the transcoder performs the conversion of MPEG-2 encoded data stored on a medium that is the copy source into AVCHD encoded data or MPEG4-AVC encoded data, a change of the compression rate, the deletion of a specific stream (secondary audio stream or the like) or the like. The AVCHD or MPEG4-AVC data generated by the transcoder is recorded on a copy destination medium (for example, a hard disk or the like).

Furthermore, as a related art describing a data conversion process, there is Japanese Unexamined Patent Application Publication No. 2010-11511, for example.

However, if such data conversion is performed, there is a case where the data format or control information before the conversion is lost or changed. As a result, the copy data recorded on the copy destination medium as converted data may not be reproduced in the same manner as the reproduction of the original data.

As a specific example of where such a problem occurs, there is multi-angle content which includes captured images from a plurality of angles, thereby enabling the display of an angle change according to, for example, input from a user. When the multi-angle content is copied, there is a problem in that information necessary for the angle change is lost or changed due to data conversion performed during a copy process, and accordingly, the angle change is not normally performed in the reproduction of the converted copy data.

### SUMMARY

The present disclosure is achieved taking the above circumstances into consideration, and in a configuration where data of content recorded on a first medium, for example, a BD or the like is converted and copied to a second medium, it is desirable to provide an information processing apparatus, an information processing method, and a program in which data conversion is executed as various reproduction aspects of original copy data is maintained, and the reproduction of the copy data after the conversion is possible in the same manner as the reproduction of the original data.

In the case where copy content is multi-angle content, for example, and where the copy content after data conversion is to be reproduced from a copy destination medium, it is also desirable for the disclosure to provide an information processing apparatus, an information processing method, and a program which realizes data conversion that enables the same angle change of the content as the original content.

According to an embodiment of the present disclosure, there is provided an information processing apparatus which includes a data processing unit which executes control of a copy process in which data recorded on a first medium is recorded on a second medium, and a data conversion unit which executes data conversion in the copy process, and the data processing unit determines whether or not data to be copied recorded on the first medium is multi-angle content for which an angle change process is permitted, and when the data to be copied is determined to be multi-angle content, angle change point information is acquired and provided to the data conversion unit, and the data conversion unit creates converted data for which decoding is possible without referring to at least a preceding picture when the picture on an angle change point location is reproduced as a reproduction start point.

Furthermore, according to the embodiment of the information processing apparatus of the disclosure, when the picture of the angle change point is an I-picture of a closed GOP, the data conversion unit may create the converted data maintaining the I-picture of the angle change point as an I-picture of a closed GOP even in the data after conversion.

Furthermore, according to the embodiment of the information processing apparatus of the disclosure, when the picture of the angle change point is an I-picture of a closed GOP and the data after conversion is AVC formatted data, the data conversion unit may perform a process of converting the I-picture of the angle change point into an IDR (Instantaneous Decoder Refresh) picture defined in an AVC format.

Furthermore, according to the embodiment of the information processing apparatus of the disclosure, when the picture of the angle change point is the IDR (Instantaneous Decoder Refresh) picture defined in the AVC format, the data conversion unit may create the converted data maintaining the IDR picture of the angle change point as the IDR picture even in the data after conversion.

Furthermore, according to the embodiment of the information processing apparatus of the disclosure, the data processing unit may execute a process of determining whether or not the data to be copied is multi-angle content with reference to recording information of a playlist file or a clip information file that are control information files of the data to be copied that is recorded on the first medium.

Furthermore, according to the embodiment of the information processing apparatus of the disclosure, the data processing unit may determine whether or not stream data designated by each playitem is data for multi-angle in a unit of playitem information of the playlist file that is a control information file of the copy target data recorded on the first medium.

Furthermore, according to the embodiment of the information processing apparatus of the disclosure, the data conversion unit may create the converted data by setting the leading picture included in a packet stipulated in a source packet number (SPN) which is recorded in an EP map of the clip information file that is a control information file of the data to be copied recorded on the first medium and indicates the packet location of an angle change point to the leading I-picture of a closed GOP or an IDR picture.

Furthermore, according to the embodiment of the information processing apparatus of the disclosure, the data conversion unit may execute a data conversion process including at least any process of conversion of an encoding format, conversion of a compression rate, or deletion of a stream.

Furthermore, according to the embodiment of the information processing apparatus of the disclosure, the information processing apparatus may further include a communication unit which executes communication with a management server, and the data processing unit may display a list of copy permitted data included in the data recorded on the first medium based on information received from the management server, and select the data to be copied based on user designation for displayed information.

Furthermore, according to another embodiment of the disclosure, there is provided an information processing method executed by an information processing apparatus, which includes data-processing by a data processing unit to execute control of a copy process in which data recorded on a first medium is recorded on a second medium, and data-converting by a data conversion unit to execute data conversion in the copy process, and in the data processing, it is determined whether or not data to be copied recorded on the first medium is multi-angle content for which an angle change process is permitted, and when the data to be copied is determined to be multi-angle content, angle change point information is acquired and provided to the data conversion unit, and the data converting is creating converted data for which decoding is possible without referring to at least a preceding picture when the picture on an angle change point location is reproduced as a reproduction start point.

Furthermore, according to still another embodiment of the disclosure, there is provided a program which causes an information processing apparatus to execute an information process, which includes data-processing for causing a data processing unit to execute control of a copy process in which data recorded on a first medium is recorded on a second medium, and data-converting for causing a data conversion unit to execute data conversion in the copy process, and in the data processing, it is caused to determine whether or not data to be copied recorded on the first medium is multi-angle content for which an angle change process is permitted, and when the data to be copied is determined to be multi-angle content, angle change point information is caused to be acquired and provided to the data conversion unit, and in the data converting, converted data is caused to be created for which decoding is possible without referring to at least a preceding picture when the picture on an angle change point location is reproduced as a reproduction start point.

Furthermore, the program of the disclosure is a program that can be provided on a recording medium and a communication medium provided in a computer readable form to an information processing apparatus or a computer system that can execute various program codes. By providing such a program in a computer readable form, processes according to the program are realized on the information processing apparatus or the computer system.

Other objects, characteristics, and advantages of the disclosure will be clarified by more detailed description based on an embodiment and accompanying drawings of the disclosure to be described later. Furthermore, a system in the present specification is a logically assembled configuration of a plurality of devices, and is not limited to a system in which devices of each configuration are included in one case.

According to the configuration of the embodiments of the disclosure, in a copy process of multi-angle content, there is provided an apparatus and a method in which data conversion enabling an angle change without problems is executed during the reproduction of copy content. When it is determined whether or not data to be copied is multi-angle content that allows an angle change process and the data is determined to be multi-angle content, converted data which enables decoding at least without referring to a preceding picture when the picture on an angle change point location is reproduced as a reproduction start point. Specifically, when a picture of an angle change point is an I-picture of a closed GOP, converted data is created by setting the I-picture of the angle change point to an I-picture of the closed GOP or an IDR picture also in data after conversion. With the process, an angle change process can be normally executed even when copy content recorded on a second medium as converted data is to be reproduced.

### BRIEF DESCRIPTION OF THE DRAWINGS

FIG. 1 is a diagram illustrating the overview of a managed copy (MC) system according to an embodiment of the present disclosure;

FIG. 2 is a diagram illustrating a unit configuration and a unit key management table;

FIG. 3 is a diagram illustrating an example of a directory structure of a medium;

FIG. 4 is a diagram illustrating the sequence of a copy process (MC) by the management of a management server;

FIG. 5 is a diagram illustrating composing data of a copy control management file (MCMF: Managed Copy Manifest File) that is recording information of a first medium;

FIG. 6 is a diagram showing an example of data included in a copy execution request;

FIG. 7 is a diagram illustrating basic information included in server response information (Offer Response);

FIG. 8 is a diagram illustrating an example of a copy process from the first medium that is the copy source to the second medium that is the copy destination (hard disk (HDD));

FIG. 9 is a diagram illustrating a structure example and use example of a playlist file;

FIG. 10 is a diagram illustrating another structure example and use example of another playlist file;

FIG. 11 is a diagram illustrating data applied to an angle change process;

FIG. 12 is a diagram illustrating the data applied to the angle change process;

FIG. 13 is a diagram illustrating the syntax (data structure) of the playlist file;

FIG. 14 is a diagram illustrating the syntax (data structure) of playitem information in the playlist file;

FIG. 15 is a diagram illustrating the syntax (data structure) of a clip information file;

FIG. 16 is a diagram illustrating ProgramInfo of the clip information file;

FIG. 17 is a diagram illustrating the syntax (data structure) of the ProgramInfo of the clip information file;

FIG. 18 is a diagram illustrating the syntax (data structure) of CPI (Characteristic Point Information) of the clip information file;

FIG. 19 is a diagram illustrating an EP map included in the clip information file;

FIGS. 20A to 20D are diagrams illustrating the EP map included in the clip information file;

FIG. 21 is a diagram illustrating the details of a content copy process executed by an information processing apparatus according to an embodiment of the disclosure;

FIG. 22 is a diagram illustrating an example of a data conversion process executed by the information processing apparatus according to an embodiment of the disclosure;

FIG. 23 is a diagram illustrating an example of the data conversion process executed by the information processing apparatus according to an embodiment of the disclosure;

FIG. 24 is a diagram illustrating the details of the content copy process executed by the information processing apparatus according to an embodiment of the disclosure;

FIG. 25 is a diagram showing a flowchart describing the sequence of a copy process executed by the information processing apparatus according to an embodiment of the disclosure;

FIG. 26 is a diagram showing a flowchart describing the sequence of the copy process executed by the information processing apparatus according to an embodiment of the disclosure;

FIG. 27 is a diagram showing a flowchart describing the sequence of the copy process executed by the information processing apparatus according to an embodiment of the disclosure;

FIG. 28 is a diagram showing a flowchart describing the sequence of the copy process executed by the information processing apparatus according to an embodiment of the disclosure;

FIG. 29 is a diagram showing a flowchart describing the sequence of the copy process executed by the information processing apparatus according to an embodiment of the disclosure;

FIG. 30 is a diagram showing an example of a playlist file updating process;

FIG. 31 is a diagram showing an example of a clip information file updating process; and

FIG. 32 is a diagram illustrating a configuration example of an embodiment of the information processing apparatus.

### DETAILED DESCRIPTION OF EMBODIMENTS

Hereinafter, an information processing apparatus, an information processing method, and a program of the present disclosure will be described in detail with reference to the drawings. Furthermore, description will be provided according to the following items.

1. Overview of Content Copy Control Process based on Server Management

2. Regarding Example of Content Recording Configuration

3. Regarding Sequence of Content Copy Process based on Server Management

4. Regarding Copy Process of Multi-Angle Content

5. Regarding Copy Process accompanying Data Conversion Process (Transcoding) executed by Information Processing Apparatus of Present Disclosure

6. Regarding Sequence of Copy Process executed by Information Processing Apparatus of Present Disclosure

7. Regarding Configuration Example of Information Processing Apparatus

### [1. Overview of Content Copy Control Process Based on Server Management]

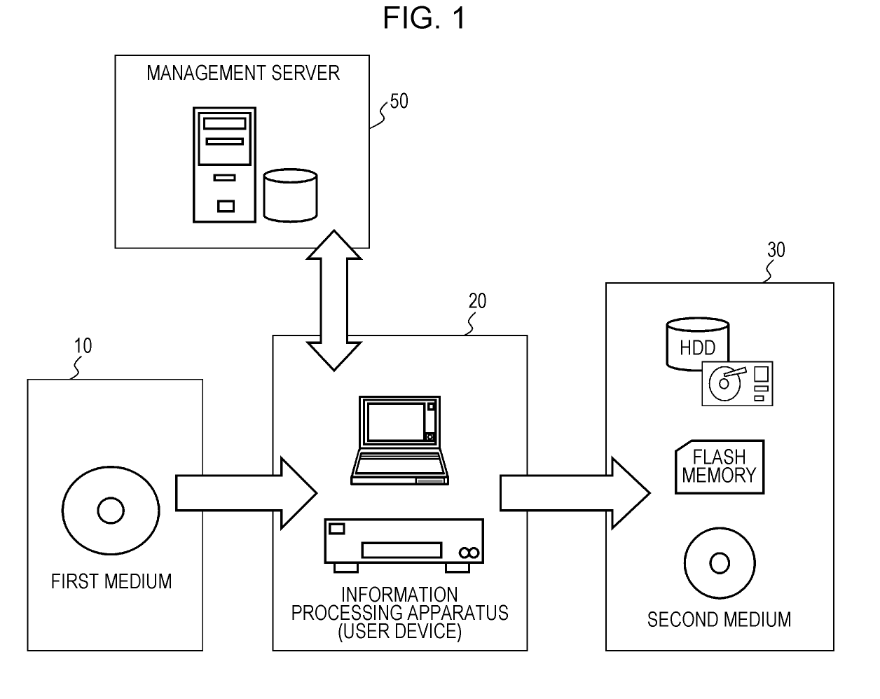

First, the overview of a content copy control process based on server management will be described with reference to FIG. 1.

The use of most content such as a movie recorded on, for example, a BD or the like is permitted under predetermined copyright management. Thus, even a user who purchased a disc is restricted in the use of content recorded on the disc to a certain degree. For example, it is not permitted that the content recorded on the disc be copied without limit to a medium such as another disc.

As such a copy management configuration of content stored on a medium, a configuration of a copy permission process on condition of obtaining copy permission information from a management server is known. FIG. 1 is a diagram illustrating the overview of a managed copy (MC) system as an example thereof.

An information processing apparatus 20 is a PC, a recorder (recording and reproducing apparatus), or the like of a user, and can be loaded with a first medium 10 on which movies or the like that are content as a copyright management target restricted in use are recorded for reproduction.

The information processing apparatus 20 enables a process of copying the content recorded on the first medium 10 to a second medium 30 that is another medium. The second medium 30 is a medium that can be used for recording in the information processing apparatus 20, and includes, for example, a hard disk (HDD), a flash memory, a data recordable disc (a BD, a DVD, or the like), or the like.

However, if a user is allowed to freely perform a copy process, duplication of content occurs en masse, thereby bringing about illegal use or distribution of copied content. In order to prevent such incidents, when the information processing apparatus 20 that is a user device executes copying of content, the apparatus is subject to connection to a management server 50 and acquisition of copy permission information from the management server 50. For the acquisition of the copy permission information, for example, it is necessary to verify the authenticity of the first medium that the user possesses and payment of a predetermined fee.

The information processing apparatus 20 as a user device can acquire copy permission information from the management server 50 and copy the content on condition of acquiring the copy permission information by performing a predetermined procedure. This is the overview of the managed copy (MC).

### [2. Regarding Example of Content Recording Configuration]

Next, a configuration example of data recorded on a medium (the first medium 10 of FIG. 1) recording, for example, use-controlled content of which copyright is managed and which is the object of the above-described managed copy (MC) will be described.

Most content such as movies recorded on a general disc that has been recorded with content thereon, for example, a BD-ROM is recorded after encryption for the purpose of preventing illegal use such as illegal copying, or the like.

The encrypted content complying with the AACS standard that is a standard relating to a content copyright protection technology is divided by units, and recorded as encrypted data to which different encryption keys are applied for each unit as described above. With the configuration of encryption for each unit, the control of use by each unit is possible and strict control of various content uses is realized.

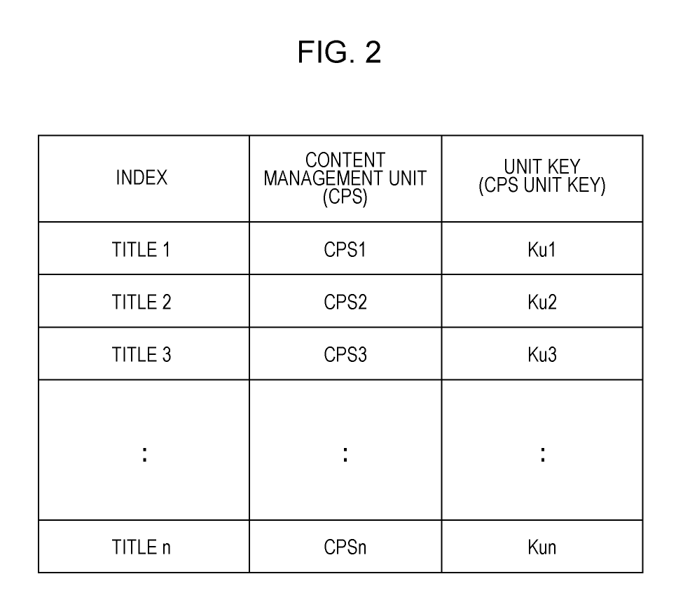

The unit which is a unit for dividing content is called a content management unit or a CPS unit, and an encryption key corresponding to each CPS unit is called a CPS unit key, a unit key, or a title key. The correspondence relationship between division of units of content recorded on a disc and encryption keys (unit keys) is shown in FIG. 2.

FIG. 2 is an example of a unit key management table showing the correspondence relationship between units (CPS units) constituting content recorded on a medium, for example, a single disc and CPS unit keys that are encryption keys. The unit key management table is recorded on a medium (a BD or the like) together with encrypted content.

As shown in FIG. 2, the CPS units that are data composing content are divided into CPS units 1 to n. Each of the CPS units 1 to n is made to correspond to each CPS unit key that is a dedicated encryption key.

For example, when the CPS unit 1 (CPS1) is to be reproduced, decryption is performed using a CPS unit key 1 (Ku1). When the CPS unit 2 (CPS2) is to be reproduced, it is necessary to perform decryption with the application of a CPS unit key 2 (Ku2). As an index corresponding to each CPS unit or CPS unit key, for example, a “title” is used. The “title” is an index set by corresponding to each CPS unit, and a CPS unit and a CPS unit key can be specified by specifying a title.

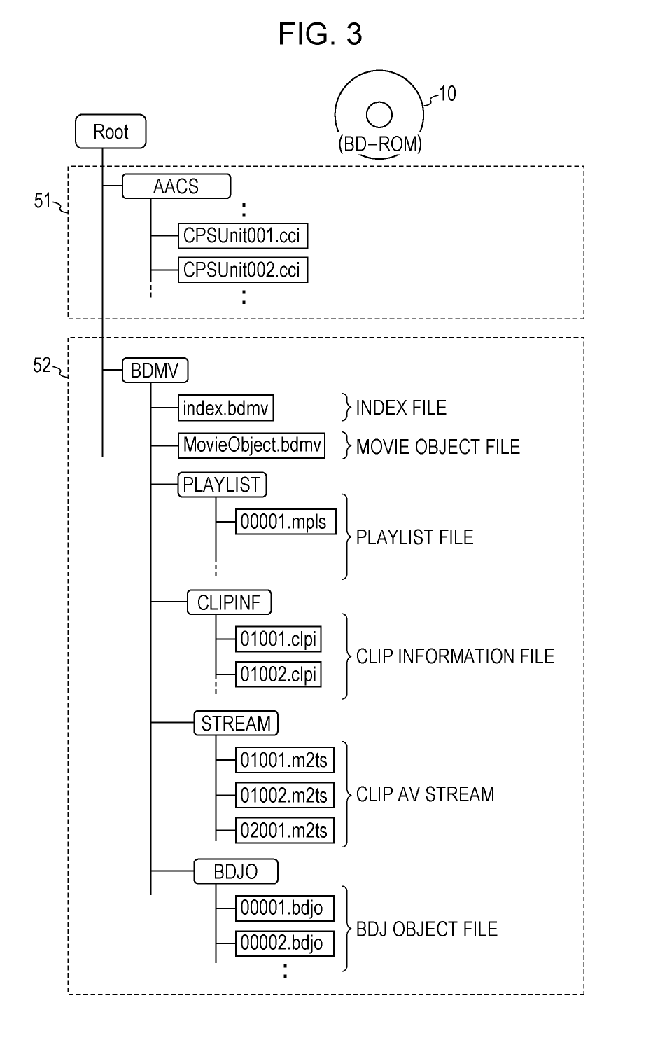

FIG. 3 is of a directory in the case where the first medium 10 is a ROM-type Blu-ray Disc (registered trademark), and shows a directory configuration corresponding to recording data of a BD.

The directory is separated into a management information setting part 51 (AACS directory) and a data part (BDMV directory) as shown in FIG. 3.

The management information setting part 51 (AACS directory) stores a CPS unit key file, a use control information file, or the like.

On the other hand, under the BDMV directory in the data part 52, the following files are recorded, for example: an index file; a movie object file; a playlist file; a clip information file; a clip AV stream file; and a BDJO file.

In the index file, title information as index information applied to a reproduction process is stored. The title is the same as registered in the unit key management table previously described with reference to FIG. 2, and data corresponding to a CPS unit.

The movie object file is a file storing a program for reproduction.

The playlist file is a file setting the reproduction sequence of content. A playlist file is selected by a title that a user selects, and a specific clip information file is designated as a reproduction target according to a playitem or path information included in the selected playlist file.

The clip information file is a file designated by the playlist file, and includes reproduction location information of the clip AV stream file, or the like.

The clip AV stream file is a file storing AV stream data that is the reproduction target.

Furthermore, there is a case where the clip information file and the clip AV stream file are called a clip or a clip file together.

The BDJO file is a file storing execution control information of a file storing a JAVA (registered trademark) program, command, or the like.

As described above, image data and audio data that are the reproduction target are stored in the clip AV stream file, and the index file, the movie object file, the playlist file, and the clip information file store various reproduction control information such as an index, a program, sequence information, data location information, and the like which are necessary for reproducing the image data and the audio data stored in the clip AV stream file, and the files are used as recording files of the reproduction control information.

The sequence that an information processing apparatus reproduces content recorded on an information recording medium is as follows.

First, a specific title is designated from the index file by a reproduction application.

A reproduction program relating to a designated title is selected.

A playlist stipulating the reproduction order of the content or the like is selected according to program information of the selected reproduction program.

Based on the clip information stipulated in the selected playlist, the AV stream or a command as content actual data is read, and the reproduction of the AV stream and an execution process of the command are performed.

In the content reproduction process, a unit and a unit key previously described with reference to FIG. 2 can be discriminated according to the selected title, the unit key corresponding to a unit as the reproduction target (encrypted content) is acquired, and a decryption process by units can be performed. When the copy process described with reference to FIG. 1 is to be executed, information acquired from the management server 50 is referred to, and data to be copied is specified to execute the copy process.

### [3. Regarding Sequence of Content Copy Process Based on Server Management]

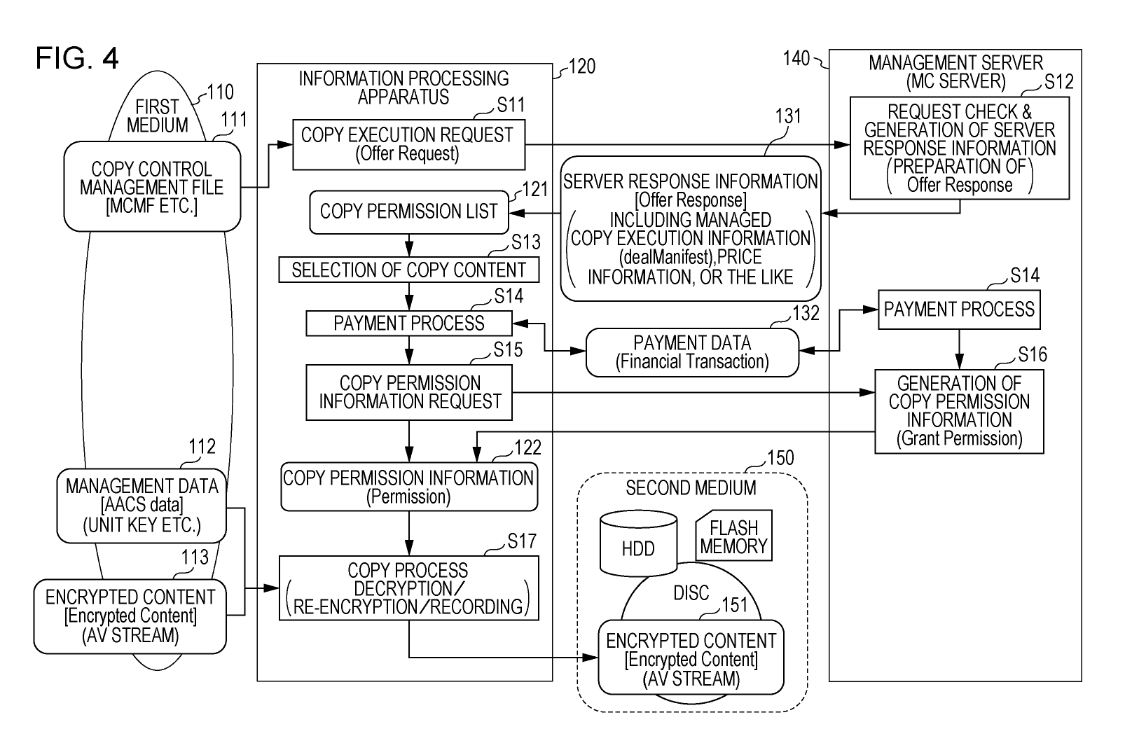

Next, the sequence of content copy process based on the server management will be described with reference to FIG. 4 and succeeding drawings. FIG. 4 is a diagram illustrating the sequence of the managed copy (MC) that is an example of a content copy process based on the server management.

FIG. 4 shows, from the left side, a first medium 110 such as a ROM disc on which content including movies has been recorded; an information processing apparatus 120 as a user device which reads data such as content from the first medium 110 and performs a copy process; a second medium 150 which is a medium as a content copy destination and constituted by a hard disk (HDD), a flash memory, an R/RE disc, or the like; a management server (MC server) 140 which executes a process of providing information such as content copy permission or the like.

The information processing apparatus 120 is constituted by, for example, a PC, a recording and reproduction apparatus, or the like, input with data read from the first medium 110, and executes a process of recording the data to the second medium 150 as a copy destination medium constituted by a hard disk (HDD), a flash memory, a R/RE disc, or the like, that is, a content copy process.

The first medium 110 is, for example, a ROM-type Blu-ray Disc (registered trademark), a DVD disc, or the like. The second medium 150 is a medium on which data can be written, and specifically includes, for example, a hard disk (HDD), a flash memory, an R-type and RE-type Blu-ray disc (registered trademark), a DVD disc, or the like.

The first medium 110 constituted by, for example, a ROM-type disc, or the like is recorded with encrypted content 113 that is use-controlled content as shown in the drawing. The encrypted content 113 includes content constituted by, for example, AV (Audio Visual) streams of moving image content such as HD (High Definition) movie content that is high-definition moving image data, music data, game programs, image files, audio data, text data, or the like.

The encrypted content 113 has a use management configuration by a content management unit (CPS unit) as previously described with reference to FIG. 2, and is encrypted content subjected to encryption with application of difference unit keys (CPS unit keys) by CPS units. In other words, in order to realize use control differently performed for each data piece divided by units, the encryption is performed with difference keys (also called CPS unit keys, unit keys, or title keys) for each unit.

Furthermore, the first medium 110 stores management data (AACS Data) 112 constituted by use control information, key information applied to decryption of the encrypted content 113, or the like, and further stores a copy control management file (MCMF: Managed Copy Manifest File) 111 used in a copy process of content recorded on the first medium 110. The copy control management file (MCMF) will be described later.

The management data 112 indicated as recording information of the first medium 110 shown in FIG. 4 is management data stipulating the AACS (Advanced Access Content System) that is a standardized management system relating to, for example, the content copyright protection technology, and data including a CPS unit key file storing keys (unit keys) applied to the decryption of the encrypted content 113, license information, content certificate (CC) indicating authenticity of the content, encryption key blocks (MKB (Media Key Block)) storing media keys for acquiring the CPS unit keys.

The MKB will be briefly described. The MKB is an encryption key block generated based on a key distribution system of a tree structure which is known as a broadcast encryption system. The MKB is a key information block that enables the acquisition of a media key [Km] that is a key necessary for decryption of content only by a process (decryption) based on a device key [Kd] stored in an information processing apparatus of a user who holds a valid license. This is a block to which an information distribution system is applied according to a so-called hierarchical tree structure, and the block makes the acquisition of the media key [Km] possible only when a user device (information processing apparatus) holds a valid license, and makes the acquisition of the media key [Km] not possible in an invalidated (revoked) user device. A memory of the information processing apparatus 120 shown in FIG. 4 stores a device key [Kd].

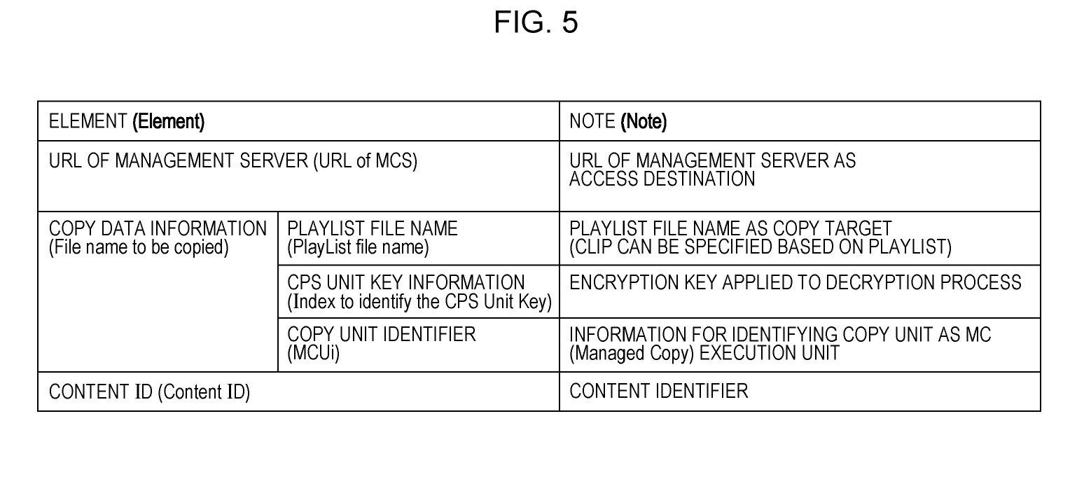

A copy control management file (MCMF: Managed Copy Manifest File) 111 indicated as recording information of the first medium 110 of FIG. 4 is a file applied when a copy process of content 113 recorded on the first medium 110 is executed, and for example, XML description data including data shown in FIG. 5.

(1) URL of the management server: This is access information to the management server providing copy permission information, and access information for the management server 140 shown in FIG. 4.

(2) Copy data information (dealManifest)
(2-1) Playlist file name: This is a file name of a playlist to be copied.
(2-2) CPS unit key information: This is identification information of a CPS unit key applied to a decryption process of content to be copied.
(2-3) Copy unit identifier: This is unit identification information of a copy unit (MC unit) indicating a unit of managed copy (MC).

(3) Content ID: This is an identifier of content that is the copy content. For example, numbers of ISAN (International Standard Audiovisual Number) are used as content code information.

With reference to FIG. 4, a process sequence will be described in which the encrypted content 113 recorded on the first medium 110 that is a ROM disc is copied to another medium including the second medium 150 or the like constituted by a hard disk, an R/RE disc, or the like.

The information processing apparatus 120 first transmits a copy execution request (Offer Request) to the management server 140 with the application of server information (the URL or the like) stored in the copy control management file (MCMF) 111 recorded on the first medium 110 in Step S11.

At this time, a content ID corresponding to the content that is the copy processing target or the like is transmitted to the management server 140.

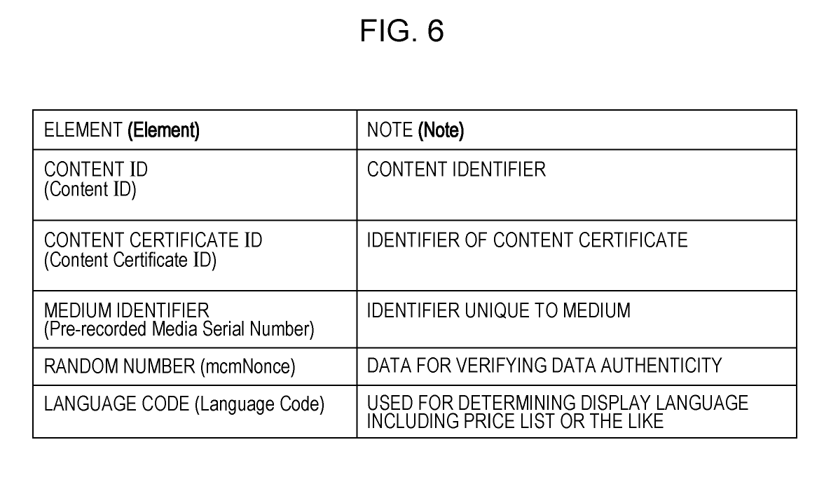

An example of data included in the copy execution request is shown in FIG. 6. As shown in FIG. 6, the copy execution request includes data, for example, as follows:

(a) Content ID: Identifier of content stored in the first medium

(b) Content certificate ID: A certificate for checking the authenticity of the above content

(c) Medium identifier: An identifier of the first medium that is the copy source

(d) Random number: Data for verifying data authenticity

(e) Language code: Information of a language code used by the information processing apparatus.

Each piece of information of (a) to (c) in the above is read from the first medium 110. (d) A random number is generated in the information processing apparatus 120. (e) The language code is transmitted by acquiring the language code recorded on the memory of the information processing apparatus 120 in advance.

Furthermore, the language code is used for determining the language of detailed offer information included in the response provided by the management server 140 or the like.

Returning to FIG. 4, the description of the sequence of the content copy process according to the server management will be continued. The management server 140 executes a verification process of the authenticity of reception information of the content ID received from the information processing apparatus 120 in Step S12, and when it is confirmed that there is no problem, server response information (Offer Response) 131 is generated and transmitted to the information processing apparatus 120.

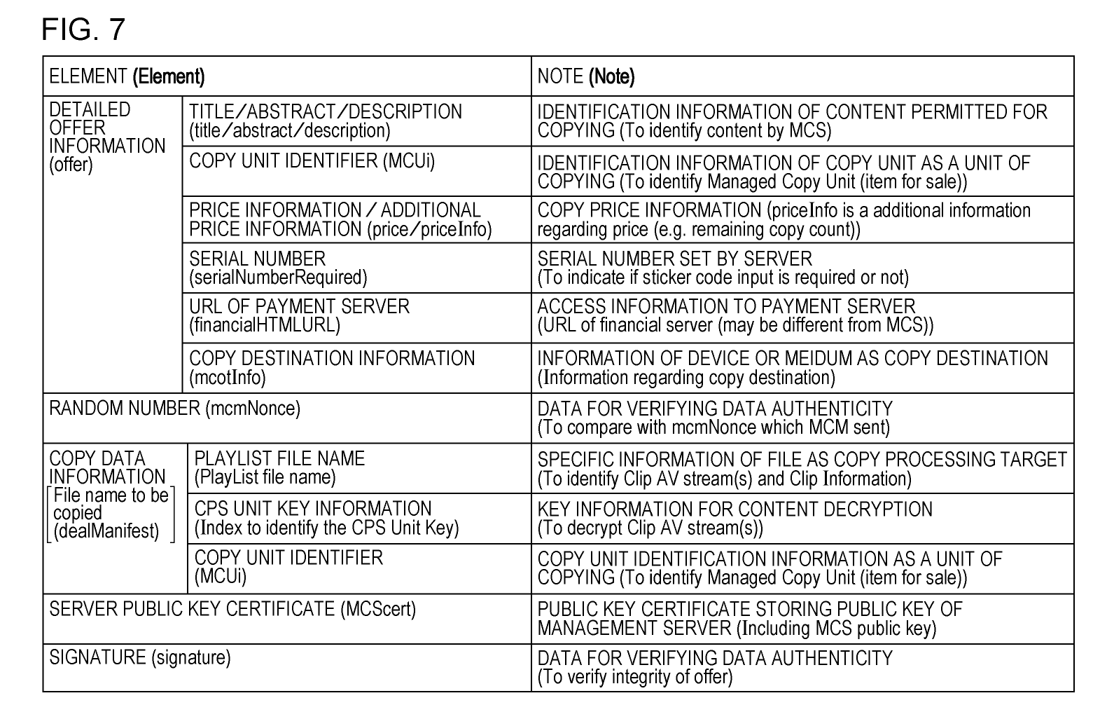

Basic information included in the server response information (Offer Response) 131 provided by the management server 140 to the information processing apparatus 120 will be described with reference to FIG. 7.

The basic information includes the following information:

(1) Detailed offer information
(1a) Title/Abstract/Description: Information of title, abstract, and description corresponding to copy permitted content
(1b) Copy unit identifier (MCU): Identifier for identifying a copy unit as a unit of copying
(1c) Price information (price): Information of copy price
(1d) Additional price information (priceInfo): Additional information of price
(1e) URL of payment server (financialHTMLURL): Access information to the server that performs a payment process of a copy fee
(1f) Copy destination information (mcotInfo): Information indicating the type, or the like of a medium permitted as a copy destination device. The information includes the type of a medium, for example, an HDD, a flash memory, or the like.

(2) Random number (mcmNonce): A random number for verifying data authenticity

(3) Copy data information (File name to be copied) (=dealManifest)
(3a) Playlist file name (PlayList file name): A file name of the playlist to be copied. A clip information file or a clip AV stream file also can be specified by specification of the playlist.
(3b) CPS unit key information (Index to identify the CPS Unit Key): Identification information of a key (CPS unit key) for decrypting copy content
(3c) Copy unit identifier (MCUi): Identification information of a copy unit (MCU) indicating a unit of copying

(4) Server public key certificate (MCScert): A certificate storing a public key of a server used in encryption communication, signature verification, or the like.

(5) Signature: Signature data for verifying falsification for the entire data

The above information is basic information included in the server response information (Offer Response) 131 provided by the management server 140 to the information processing apparatus 120. The information is set for each copy unit (MCU) as a unit of a copy process.

For example, even for the same content A, the copy unit is set according to a copy destination medium. In other words, the setting is performed as:

a copy unit 0001 of the content A for a hard disk; and

a copy unit 0002 of the content A for a flash memory.

Furthermore, the server response information (Offer Response) 131 shown in FIG. 7 includes the same information as the information stored in the copy control management file (MCMF) 111 recorded on the first medium 110 described with reference to FIG. 5 before. In other words, the information is (3) copy data information (File name to be copied) (=dealManifest) described above. The information is subjected to a copy process prior to reception information from the management server 140. The reason is that the reception information from the management server 140 has the possibility of being updated sequentially.

Returning to FIG. 4, the description of the sequence of the content copy process according to the server management will be continued. The management server 140 executes the verification process of the authenticity or the like of the received information of the content ID or the like received from the information processing apparatus 120 in Step S12, and when it is confirmed that there is not a problem, the server response information (Offer Response) 131 is generated and transmitted to the information processing apparatus 120.

The information processing apparatus 120 that receives the server response information (Offer Response) 131 displays a list of copy permitted content (copy permission list 121) on a display unit of the information processing apparatus 120 with application of the response information (Offer Response) 131 received from the management server 140. The list sets, for example, the price, or the like for executing copying each content piece.

In Step S13, a user executes the selection of content for designating content as the copy target from the list of copy permitted content. Furthermore, in Step S14, the information processing apparatus 120 executes a payment process for a copy process between the management server 140. Specifically, a transfer process of payment data 132 is performed between the information processing apparatus 120 and the management server 140. Furthermore, a server which executes the payment process may be a payment server different from the management server. In addition, when copying of content of which a copy process is set to free of charge is to be executed, the payment process is omitted.

After completion of the payment process executed according to necessity, the information processing apparatus 120 transmits a request of copy permission information to the management server 140 in Step S15. The management server 140 checks the completion of the payment, generates copy permission information 122, and transmits the information to the information processing apparatus 120 according to the request of the copy permission information from the information processing apparatus 120 in Step S16.

The information processing apparatus 120 executes a content copy process in Step S17 with the condition of receiving the copy permission information 122 from the management server 140. In other words, the encrypted content 113 is read from the first medium 110, a decryption process is performed with the selection of data to be copied, and data copying is performed on the second medium 150 constituted by a hard disk (HDD), a flash memory, an R/RE disc or the like that is a copy destination.

Furthermore, the content copy process is executed, for example, in the following order. The sequence of the process is:

(1) Reading of encrypted content from the first medium 110 (copy source medium);

(2) Decryption process of the encrypted content according to a first management system corresponding to the first medium 110 (copy source medium);

(3) Encryption process of the content according to a second management system corresponding to the second medium 150 (copy destination medium); and (4) Recording process of the encrypted content on the second medium 150 (copy destination medium).

As such, when encrypted content is read from a disc and copied to a medium such as another disc or the like, the encrypted content to be copied is decrypted first, and then a process in which re-encryption is executed according to a standard of a copyright management system corresponding to the copy destination medium for recording is performed. By performing the process, use control is possible in the copy destination medium, and illegal use and distribution of copied content can be prevented.

Furthermore, a collective term of a content copyright management system relating to digital data is a DRM (Digital Rights Management) system. Media recordable with digital data is diversified, and various DRM systems according to the media are adopted. When digital data is copied between media adopting different DRM systems, copying is performed after changing from a DRM system that a copy source medium adopts to a DRM system that a copy destination medium adopts. With such a configuration, illegal use and distribution of copied content can be prevented.

In that case, if a management system of the copy source (set to a first DRM) and a content management system of the copy destination (set to a second DRM) are different from each other, it is necessary that encrypted content of the copy source is decrypted following the sequence of the above-described (1) to (4) first, and a process according to the management system of the copy destination (the second DRM), for example, recording by using a different encryption key and performing re-encryption and encoding is performed.

When the first management system is a system according to the AACS standard, a decryption process of the encrypted content according to the above-described first management system of (2) is performed as a decryption process by CPS units with application of CPS unit keys.

Furthermore, the second management system corresponding to a copy destination medium (the second medium 150) may adopt the AACS standard, and is considered to be another management system such as CPRM, MagicGate, VCPS, or the like, corresponding to various standards according to the media.

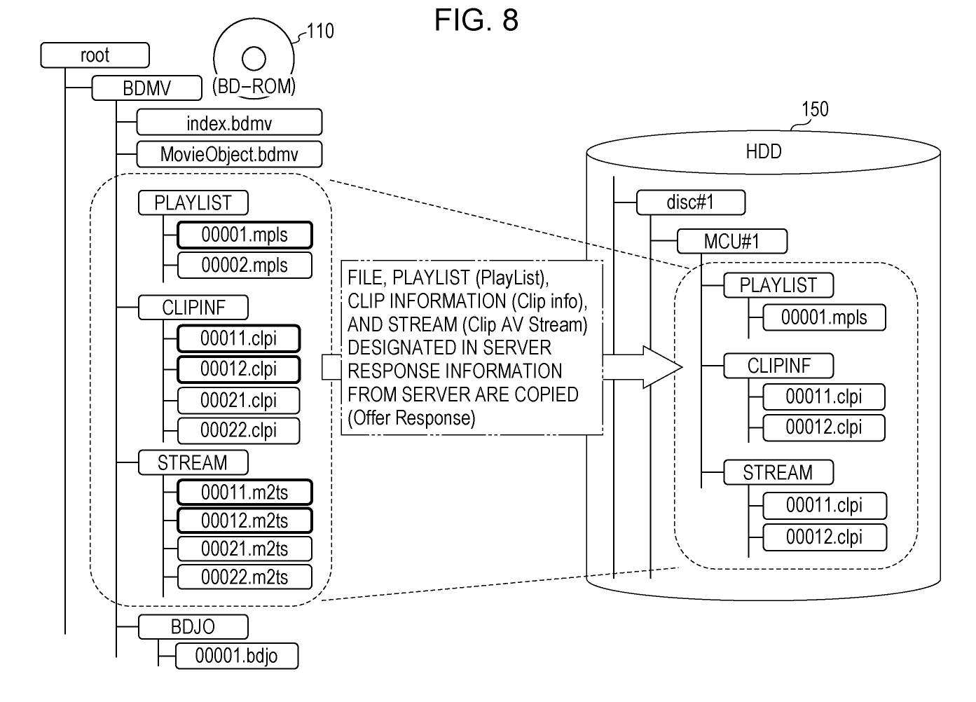

FIG. 8 shows an example of specific copying. FIG. 8 shows the first medium 110 that is the copy source and a hard disk (HDD) as an example of the second medium 150 that is the copy destination.

As shown in the left side of FIG. 8, the first medium 110 is recorded with various files according to the directory configuration previously described with reference to FIG. 3. A process is executed in which specific files are selected from a number of the files, and only the selected files are copied to the hard disk (HDD) that is the second medium 150.

An example is shown where files indicated by thick lines are selected from the directory of the first medium 110 shown in the left side of FIG. 8 and copied. In other words, the following files are selected and copied:

a playlist file (PLAYLIST): 00001.mpls;

a clip information file (CLIPINF): 00011.clpi, 00012.clpi; and

an AV stream file: 00011.m2ts, 00012.m2ts.

As such, in a copy process for example, management information files such as an index file, a movie object file, or the like are not copied, but only the playlist file to the AV stream file are recorded.

Furthermore, the file selection is executed with application of information included in the server response information (Offer Response) 131 previously described with reference to FIG. 7.

As previously described with reference to FIG. 7, the server response information (Offer Response) 131 is recorded with:
(3a) Playlist file name;
(3b) CPS unit key information; and
(3c) Copy unit identifier (MCUi)

As (3) copy data information (File name to be copied) (=dealManifest), a copy unit is selected as a unit of copying with application of the above information, and a playlist file name corresponding to the selected copy unit is acquired to acquire a playlist file. Furthermore, a clip information file and a clip AV stream file designated by the acquired playlist file are acquired. Furthermore, a CPS unit key corresponding to a copy unit is acquired to execute decryption of content such as the clip AV stream file, or the like. Then, furthermore, after an encryption process corresponding to the DRM system of the second medium 150 or the like is executed, a file is set in the hard disk (HDD) that is the second medium 150.

### [4. Regarding Copy Process of Multi-Angle Content]

As described above, even for use-controlled content, a copy process (MC: Managed Copy) is possible under server management, and a user can perform reproduction or use of the content from the second medium that is the copy destination medium.

However, as previously described, there are many cases where a data conversion process is performed by a transcoder (data conversion unit) in order to increase, for example, a compression rate in the copy process. For example, the transcoder performs a process of converting MPEG-2 encoded data stored on a medium of the copy source into AVCHD encoded data, MPEG4-AVC encoded data, or the like. The AVCHD or MPEG4-AVC data generated by the transcoder is recorded on a copy destination medium (for example, a hard disk, or the like).

However, if the data conversion is performed as above, the data format or control information of the data before the conversion may be lost or changed. As a result, the copied data recorded on the copy destination medium as converted data may be recorded after turning into data that is not able to be reproduced in the same manner as the original data.

Particularly, when the data to be copied is multi-angle content, a problem may be caused in that loss or change of information necessary for an angle change occurs, and the angle change is not able to be normally performed in the reproduction of copied data after conversion.

Furthermore, multi-angle content includes images captured from a plurality of angles, and is content that enables the display of the angle change according to, for example, inputs from a user.

Hereinbelow, a configuration for solving the problem will be described.

In the case of multi-angle content recorded in an MPEG-2 format on a BD-ROM, data locations (angle change points (locations)) that can be changed to a video with other angles are stipulated in advance.

It is necessary that reproduction target data (constituent data of a clip AV stream (picture)) that is an angle change point satisfies a predetermined condition.

In addition, it is necessary that information of data locations of the angle change point or the like is recorded in a reproduction control information file (clip information file, playlist file, or the like) in order to perform an angle change reproduction process.

If a transcoder (data conversion unit) executes conversion (transcoding) in an encoded format in the copy process, the above-described reproduction target data (clip AV stream) or the reproduction control information file (clip information file, playlist file, or the like) is converted, the conversion causes a change or loss of data or control information necessary for a normal angle change, and accordingly, the angle change of copied data after the conversion is not possible.

In MPEG-2 formatted data, a picture of an angle change point is conditioned to be a leading picture of a Closed GOP constituting the clip AV stream. The Closed GOP will be described later.

In addition, when angle change reproduction is performed, it is necessary that packet location information (SPN: Source Packet Number) of an angle change point in, for example, the clip AV stream is acquired from the reproduction control information file (clip information file).

In a data conversion process during a copy process, if such a data condition or reproduction control information of the angle change point is lost, a normal angle change is not possible during the reproduction of copied content from the second medium that is the copy destination medium.

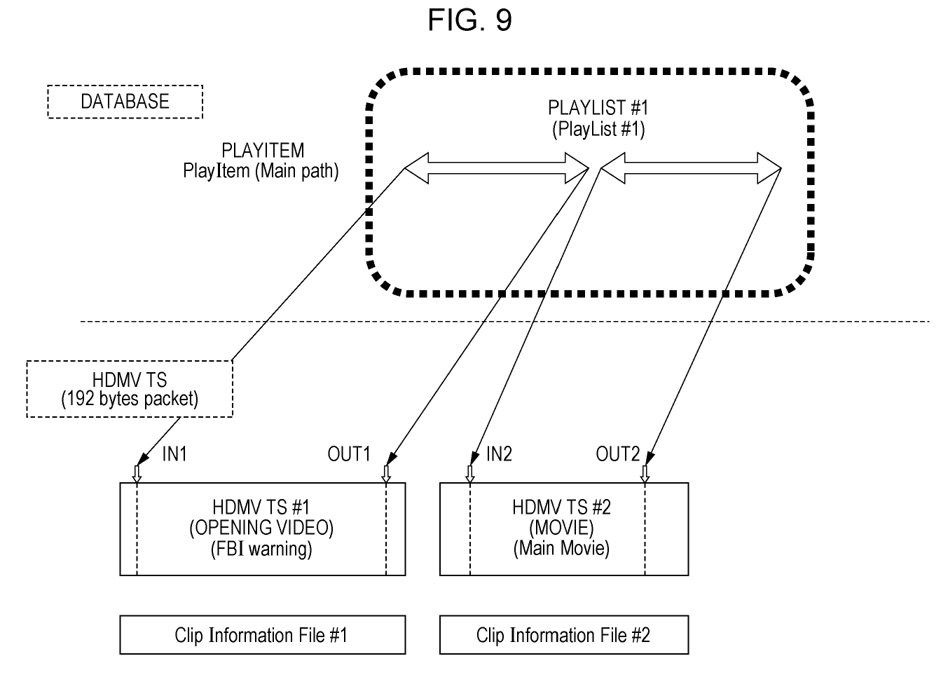

First, a data configuration of the original content that is data to be copied and is recorded on the first medium will be described with reference to FIG. 9 and succeeding drawings.

Data described below is an example of data recorded on a BD-ROM disc according to an MPEG-2 encoded format.

A configuration example of the playlist file and clip information file that are control information files and the clip AV stream file that is a file storing reproduction data will be described.

First, a configuration example and a use example of the playlist file set on a disc storing the original content that is the copy source will be described with reference to FIG. 9.

FIG. 9 shows a content reproduction process example using a PlayList file #1 set on a disc storing the original content that is the copy source.

A reproduction process is executed such that a specific playlist is selected, for example, according to a title of which reproduction is designated by a user, and clips (clip information file and clip AV stream file) are selected according to the playlist.

The PlayList file #1 shown in FIG. 9 is an example of a playlist with the simplest configuration. A playitem having reproduction designation information indicating a reproduction start location and end location for the clip information file of video content is set therein. A playitem is composed of two playitems, which are:

a first playitem with a reproduction start point (IN1) and a reproduction end point (OUT1) of the opening video; and

a second playitem with a reproduction start point (IN2) and a reproduction end point (OUT2) of the main movie.

When the PlayList file #1 is selected according to, for example, the title of which reproduction is designated by a user, clips (clip information file and clip AV stream file) having the opening video are selected according to the preceding playitem of the PlayList file #1 and reproduced, and after that, clips (clip information file and clip AV stream file) of the main movie are selected and reproduced according to succeeding playitems.

The structure of the playlist file is not limited to a file having a simple structure as the PlayList file #1 shown in FIG. 9. There is a playlist file with a complicated structure for performing various complicated data reproduction processes.

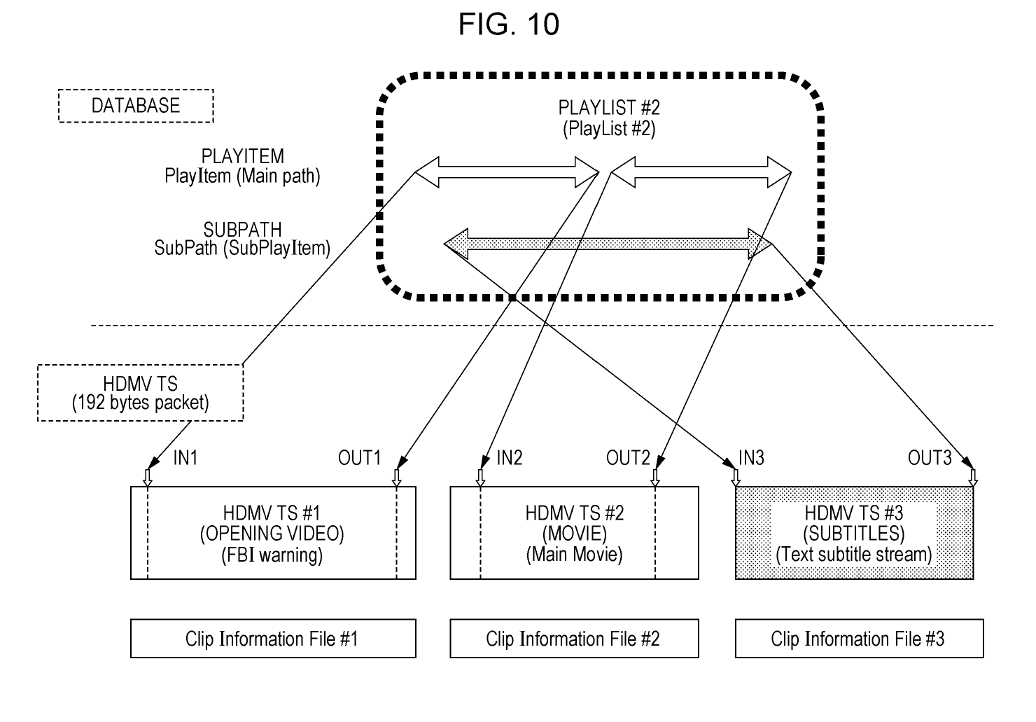

As an example of a playlist file realizing complicated data reproduction, an example of a PlayList file having a subpath will be described with reference to FIG. 10.

A PlayList file #2 shown in FIG. 10 is set with a playitem having reproduction designation information indicating the reproduction start location and end location for a clip information file of video content and a subpath having reproduction designation information of subtitles. The playitem is constituted by two playitems, which are:

a first playitem with a reproduction start point (IN1) and a reproduction end point (OUT1) of the opening video; and

a second playitem with a reproduction start point (IN2) and a reproduction end point (OUT2) of the main movie.

The subpath is composed as information having a reproduction start point (IN3) and a reproduction end point (OUT3) of subtitle data.

For example, when subtitle data designated by the subpath is Japanese subtitle, image content is reproduced from a clip information file designated by the playitem of the PlayList file #2 and the subtitle data is reproduced from the clip storing the subtitle data selected with the subpath, in accordance with the reproduction of the content.

When English subtitles are displayed, for example, a different playlist file is used.

When a PlayList file includes a playitem and a subpath corresponding to a main path as above, a reproduction process using two pieces of path information is possible, and subtitle reproduction together with video reproduction is possible.

Furthermore, there are a file with a subpath set as shown in FIG. 10 and a file with a subpath not set as shown in FIG. 9 in a playlist file, and a medium such as a BD or the like storing the original content is recorded with a number of playlist files in different types.

In the case of multi-angle content, a plurality of clip AV stream files storing each of images captured from different angles and a plurality of PlayList files corresponding to the number of clip AV stream files are used.

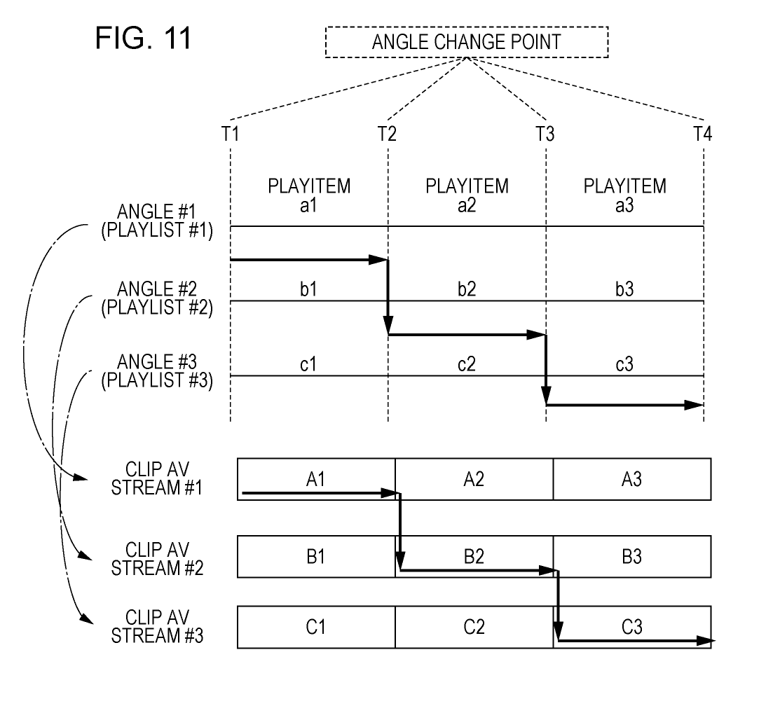

For example, an example in which three angles (angle #1, angle #2, and angle #3) are set in a reproduction segment including multi-angle content will be described with reference to FIG. 11.

As shown in FIG. 11, clip AV streams #1 to #3 storing images captured from each angle are used. Each of the clip AV streams #1 to #3 is reproduced using the PlayLists #1 to #3 set corresponding thereto.

In the case of the example shown in FIG. 11, the angle #1, the angle 2, and the angle #3 are respectively reproduced by the PlayList #1, the PlayList #2, and the PlayList #3. In the case of the example shown in FIG. 11, the reproduction segment is divided into different playitems at a time point in which angles can be shifted from one to another (angle change point).

For example, when the reproduction segment of the angle #1 is divided into three, the PlayList #1 is constituted by three playitems corresponding to each of reproduction segments a1, a2, and a3, and AV stream data pieces of a Clip #1 corresponding to each of the reproduction segments a1, a2, and a3 are set to A1, A2, and A3.

When the reproduction segment of the angle #2 is divided into three, the PlayList #2 is constituted by three playitems corresponding to each of reproduction segments b1, b2, and b3, and AV stream data pieces of a Clip #2 corresponding to each of the reproduction segments b1, b2, and b3 are set to B1, B2, and B3.

When the reproduction segment of the angle #3 is divided into three, the PlayList #3 is constituted by three playitems corresponding to each of reproduction segments c1, c2, and c3, and AV stream data pieces of a Clip #3 corresponding to each of the reproduction segments c1, c2, and c3 are set to C1, C2, and C3.

The playitem of the reproduction segment a1, b1, and c1 has a pair of the same IN point (IN_time) and OUT point (OUT_time), and for example, the IN_time is T1 and the OUT_time is T2. In the same manner, the playitem of the reproduction segment a2, b2, and c2 has a pair of the same IN point (IN_time) and OUT point (OUT_time), and for example, the IN_time is T2 and the OUT_time is T3. Furthermore, the playitem of the reproduction segment a3, b3, and c3 has a pair of the same IN point (IN_time) and OUT point (OUT_time), and for example, the IN_time is T3 and the OUT_time is T4. In this case, the T1, T2, T3, and T4 are reproduction time information, and each indicates a PTS (Presentation Time Stamp) showing a reproduction time on an AV stream.

A basic process when an angle is seamlessly changed in the reproduction process of multi-angle content will be described. A control unit of a reproduction apparatus that executes reproduction of multi-angle content determines whether or not the instruction of an angle change has been input from the user. When the instruction of the angle change is detected, the control unit determines whether or not the current reproduction location is an angle change point. When the current reproduction location is not an angle change point, the control unit stands by until the reproduction location reaches the angle change point.

When it is determined that the reproduction location reaches the angle change point, the control unit causes the reproduction location to be shifted (to jump) to the leading location of the AV stream defined as the playitem of the designated angle. Then, data of the AV stream is reproduced.

As such, the angle change is sequentially performed according to, for example, the instruction of the user. In the example of FIG. 11, the AV stream data A1 of the clip AV stream #1 corresponding to the reproduction segment of the angle #1 is reproduced, the AV stream data B2 of the clip AV stream #2 corresponding to the reproduction segment of the angle #2 is reproduced, and next, the AV stream data C3 of the clip AV stream #3 corresponding to the reproduction segment of the angle #3 is sequentially reproduced.

Information of the leading address and the end address of each playitem and information of the data size (the amount of byte) can be obtained from a clip information file of each clip.

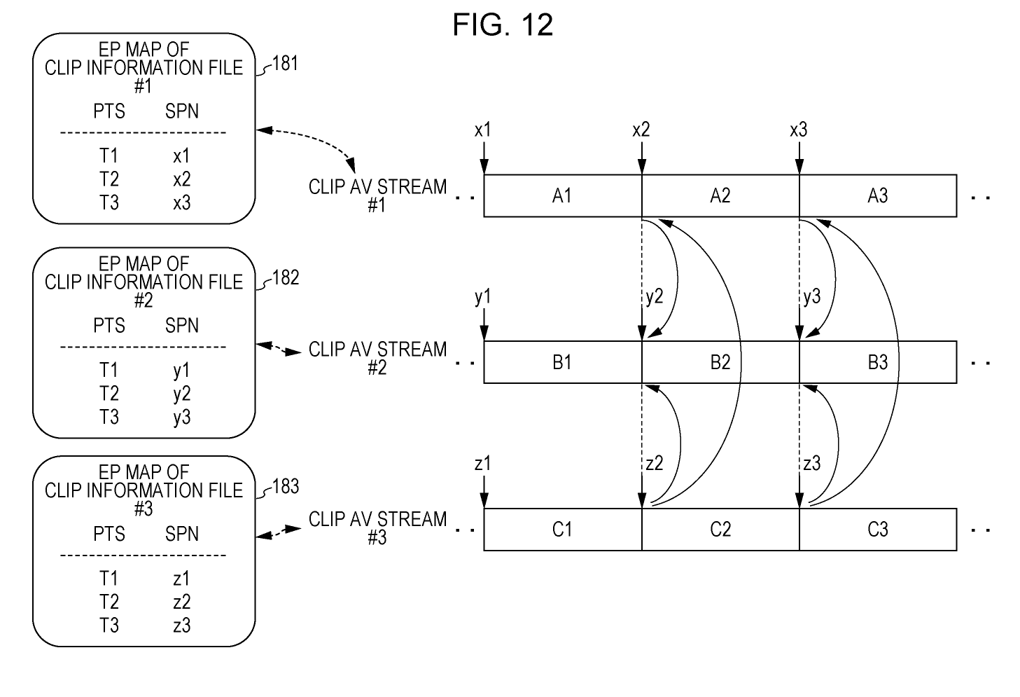

FIG. 12 is a diagram illustrating data content of the clip information file applied to an angle change process.

Each of video stream data in the AV stream data A1, B1, and C1 starts from a Closed GOP that starts from a sequence header. The time stamp (PTS: Presentation Time Stamp) indicating the reproduction time of the display start of each data is the same as T1, and the display term of each data is the same as (T1-T2).

Furthermore, a Closed GOP (Closed Group of Pictures) is a GOP that is closed in one reproduction segment (for example the reproduction segment A1, B1, C1, or the like), and a group of encoded pictures so as to be completed in the segment.

MPEG encoded data is constituted by an I-picture that is an encoded image which can be subjected to an encoding or decoding process without a reference image, a P-picture for performing an encoding or decoding process with one picture as a reference image, and a B-picture for performing an encoding or decoding process with two pictures as reference images. The P-picture and B-picture performs encoding or decoding with reference to a preceding or a succeeding image.

A GOP is defined as a unit of a set constituted by a plurality of I/P/B-pictures (an encoding process unit). A stream is constituted by a plurality of GOPs.

A Closed GOP is a GOP with a set that can execute an encoding/decoding process of each of I/P/B pictures included in a GOP without referring to a picture of a GOP other than the Closed GOP.

In a stream, such a Closed GOP and a GOP that is not closed and has to refer to a picture in another GOP for an encoding/decoding process are mixed.

A picture location that is an angle change point is preferably a leading I-picture of a Closed GOP.

Each of video stream data in the AV stream data A2, B2, and C2 starts from a Closed GOP that starts from a sequence header, and the time stamp (PTS: Presentation Time Stamp) of the display start of each data is the same as T2, and the display term of each data is the same as (T2-T3).

Furthermore, each of video stream data in the AV stream data A3, B3, and C3 starts from a Closed GOP that starts from a sequence header, and the time stamp (PTS: Presentation Time Stamp) of the display start of each data is the same as T3, and the display term of each data is the same as (T3-T4).

Furthermore, in video stream data of all AV stream data A1, B1, C1, A2, B2, C2, A3, B3, and C3, a picture displayed first in the Closed GOP is an I-picture.

The audio stream data pieces in the AV stream data A1, B1, and C1 are the same, the audio stream data pieces in the AV stream data A2, B2, and C2 are the same, and the audio stream data pieces in the AV stream data A3, B3, and C3 are also the same.

Furthermore, the AV stream data A1, B1, and C1 include a video packet storing the video data as well as an audio packet storing audio data, a presentation graphics (PG) packet storing subtitle data, or the like. The leading packet of each of the AV stream data A1, B1, and C1 is set to a video packet, and the payload thereof starts with an I-picture that starts from a sequence header and a GOP header.

The leading packet of each of the AV stream data A2, B2, and C2 is also set to a video packet, and the payload thereof starts with an I-picture that starts from a sequence header and a GOP header.

The leading packet of each of the AV stream data A3, B3, and C3 is set to a video packet, and the payload thereof starts with an I-picture that starts from a sequence header and a GOP header.

In addition, as described above, the GOP including the leading I-picture is set as a Closed GOP that can perform encoding and decoding only with I/B/P-pictures in the GOP. By adopting such a setting, a decoding reproduction is possible according to an angle change, without referring to a picture of another GOP in image reproduction from an angle change point of video stream data of all A1, B1, C1, A2, B2, C2, A3, B3, and C3.

A clip information file that is one of reproduction control information files relating to the clip AV stream file is recorded with a time stamp (PTS: Presentation Time Stamp) as reproduction time information of an entry point (EP) that is a location where random reproduction is possible in a clip, and an EP_map that is a map recorded with data corresponding to a source packet number (SPN) indicating a packet location (the number of packets from the leading part) in the clip AV stream file.

Furthermore, a source packet number (SPN) refers to a number which increases one by one in the order of source packets in the clip AV stream file, and the source packet number of the leading part of the clip AV stream file is set to zero.

For example, x1, x2, and x3 that are packet numbers (SPN) of the leading part of the AV stream data A1, A2, and A3 corresponding to angle change points constituting the clip AV stream file #1 shown in FIG. 12 correspond to the number of packets from the leading part (the front side of the data A1) of the clip AV stream file #1.

In the same manner, y1, y2, and y3 that are packet numbers (SPN) of the leading part of the AV stream data B1, B2, and B3 corresponding to angle change points constituting the clip AV stream file #2 correspond to the number of packets from the leading part (the front side of the data B1) of the clip AV stream file #2.

In the same manner, z1, z2, and z3 that are packet numbers (SPN) of the leading part of the AV stream data C1, C2, and C3 corresponding to angle change points constituting the clip AV stream file #3 correspond to the number of packets from the leading part (the front side of the data C1) of the clip AV stream file #3.

In the case of the above setting, the EP map recorded in the clip information file #1 to #3 corresponding to each of the clip AV stream files #1 to #3 is an EP map including data indicating EP maps 181 to 183 shown in FIG. 12.

The EP map 181 of the clip information file #1 of the clip AV stream #1 is recorded with packet locations x1, x2, and x3 (the number of packets from the leading part of the clip AV stream #1) of an angle change point and PTSs T1, T2, and T3 indicating reproduction time information of the packets corresponding thereto. A source packet designated by x1, x2, and x3 is a packet that starts from an I-picture of the Closed GOP.

The EP map 182 of the clip information file #2 of the clip AV stream #2 is recorded with packet locations y1, y2, and y3 (the number of packets from the leading part of the clip AV stream #2) of an angle change point and PTSs T1, T2, and T3 indicating reproduction time information of the packets corresponding thereto. A source packet designated by y1, y2, and y3 is a packet that starts from an I-picture of the Closed GOP.

The EP map 183 of the clip information file #3 of the clip AV stream #3 is recorded with packet locations z1, z2, and z3 (the number of packets from the leading part of the clip AV stream #3) of an angle change point and PTSs T1, T2, and T3 indicating reproduction time information of the packets corresponding thereto. A source packet designated by z1, z2, and z3 is a packet that starts from an I-picture of the Closed GOP.

The control unit of a reproduction apparatus for reproducing multi-angle content acquires a packet location of an angle change point with reference to an SPN registered in an EP_map included in a clip information file. Furthermore, an angle change reproduction process is executed by performing decoding of the above-described Closed GOP from the packet of the acquired packet location for reproduction.

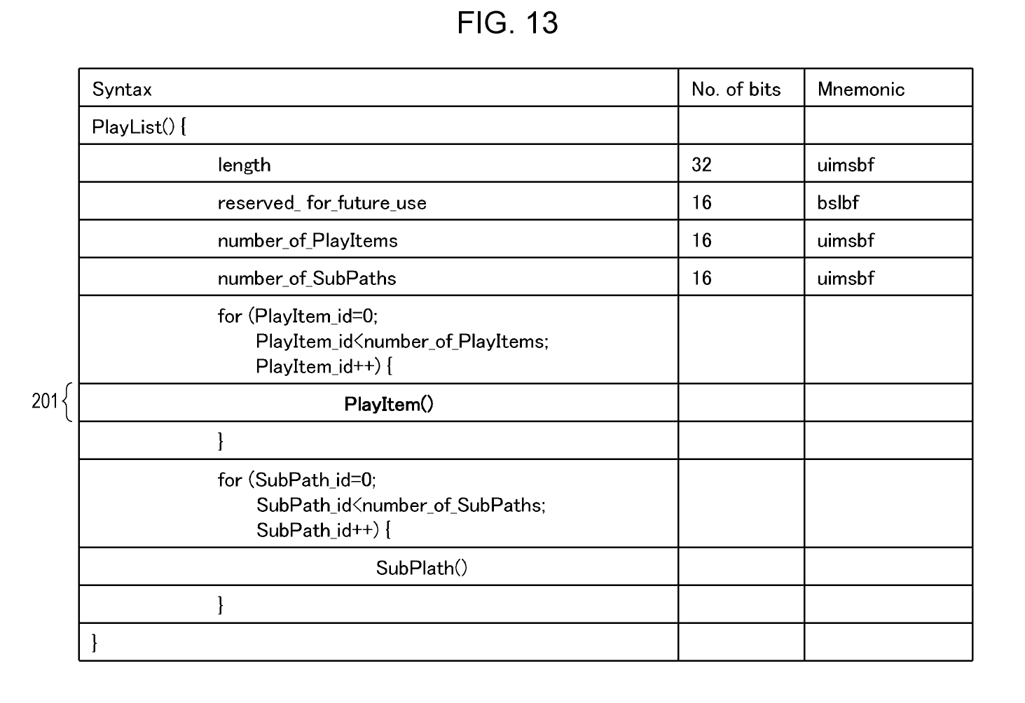

Next, the specific sequence (data structure) of each of the following files that are reproduction control information files recorded on the first medium as the copy source will be described with reference to FIG. 13 and succeeding drawings.

The specific configuration of files below will be described in order: (A) PlayList file; and (B) Clip information file.

### (A) PlayList File

First, the syntax (data structure) of the PlayList file (PlayList( )) will be described with reference to FIG. 13.

A length is a 32-bit unsigned integer indicating the number of bytes from right after the length field to the end of PlayList( ). In other words, the length is a field indicating the number of bytes from reserved_for_future_use to the end of PlayList. After the length, 16-bit reserved_for_future_use is prepared.

number_of_PlayItems is a 16-bit field indicating the number of playitems (PlayItem) in the playlist (PlayList). For example, in the examples of FIGS. 9 and 10, the number of playitems (PlayItem) is two. The value of PlayItem_id is allocated from 0 in the order that PlayItem( ) appears in PlayList.

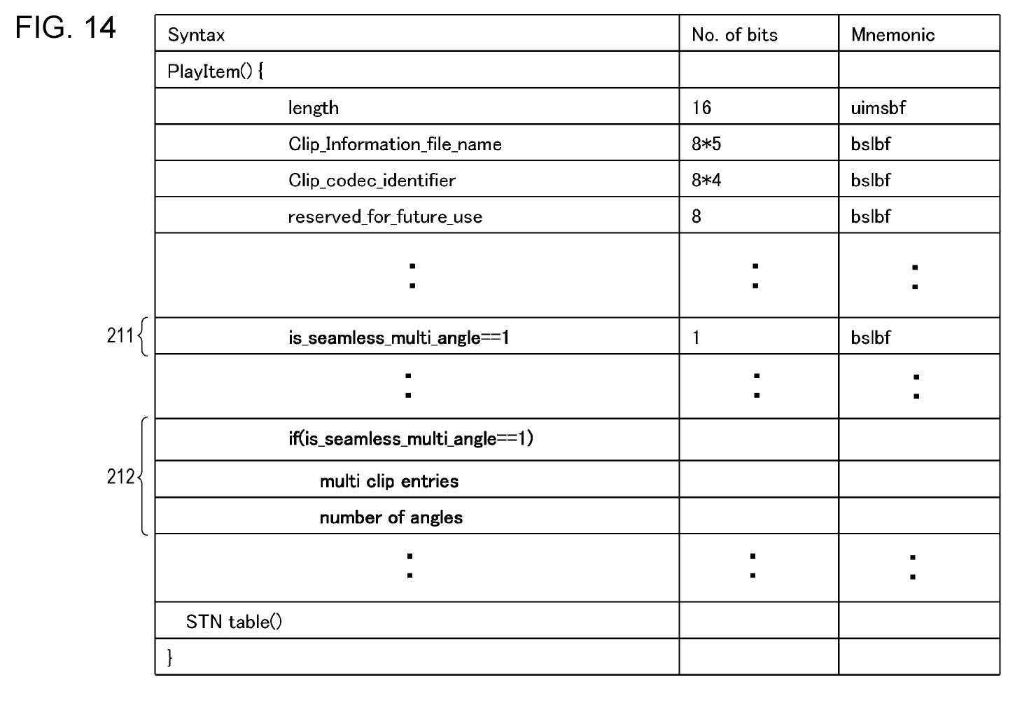

A field 201 of PlayItem( ) is recorded with detailed information of each playitem. The field is recorded with information of clips or the like designated by each playitem. The detailed information will be described with reference to FIG. 14 in the later part.

number_of_SubPaths is a 16-bit field indicating the number (entry number) of subpaths (SubPath) in the playlist (PlayList). For example, in the example of the playlist shown in FIG. 10, the number of subpaths (SubPath) is one. The value of SubPath_id is allocated from 0 in order that SubPath( ) appears in PlayList.

A block of SubPath( ) is recorded with detailed information of each subpath. There is recorded with a reproduction start point, a reproduction end point, and the like of a clip designated by each subpath.

FIG. 14 is a diagram showing a part of the syntax of the block of PlayItem( ), and mainly shows fields relating to the present disclosure.

A field of length has a 16-bit data length, and shows a data length from right after the field of length to the end of the block of PlayItem( ).

A field of Clip Information_file_name[0] has a 40-bit (5 bytes) data length, and shows a file name of a clip information file that the block of PlayItem( ) refers to. In the playitem, the clip information file of the file name indicated by the field of Clip_Information_file_name[0] is read. A field of Clip_codec_identifier[0] has a 32-bit (4 bytes) data length, and shows a codec scheme of a clip AV stream used in the playitem by the block of PlayItem( ).

A multi-angle content identification field 211 is a field where a flag with a 1-bit data length is set. is_seamless_multi_angle is set with a flag indicating whether or not it corresponds to multi-angle.

In the case of is_seamless_multi_angle==1, data reproduced by the playitem is content corresponding to multi-angle, and a playitem corresponding to the clip AV stream selected and reproduced according to an angle change request from a user.

In the case of is_seamless_multi_angle==0, this indicates that data reproduced by the playitem is not content corresponding to multi-angle.

A multi-angle content management information recording field 212 is a management information recording field of multi-angle content. For example, there is described with information relating to clips, angle numbers, or the like. If the value of the flag is_multi_angle of the multi-angle content identification field 211 is a value (is_seamless_multi_angle==1) indicating that the data corresponds to multi-angle, information for managing multi-angle indicated in an if statement, for example, information relating to clips, angle numbers, or the like is described.

Furthermore, although omitted in FIG. 14, the block of PlayItem( ) is further recorded with clip designation information of IN_time (reproduction start point) and OUT_time (reproduction end point) indicating the reproduction range of a clip AV stream.

In addition to that, there are recorded with the following information, for example:

a field of connection condition indicating information relating to the connection_state of reproduced data in a reproduction process by a plurality of playitems;

a flag of PlayItem_random_access_flag stipulating whether or not random access is to be permitted for the playitem; and

a block of STN_table( ) indicating an attribute, a PID number, a recording location on a recording medium of a clip AV stream managed by the playitem according to PlayItem( ).

### (B) Clip Information File

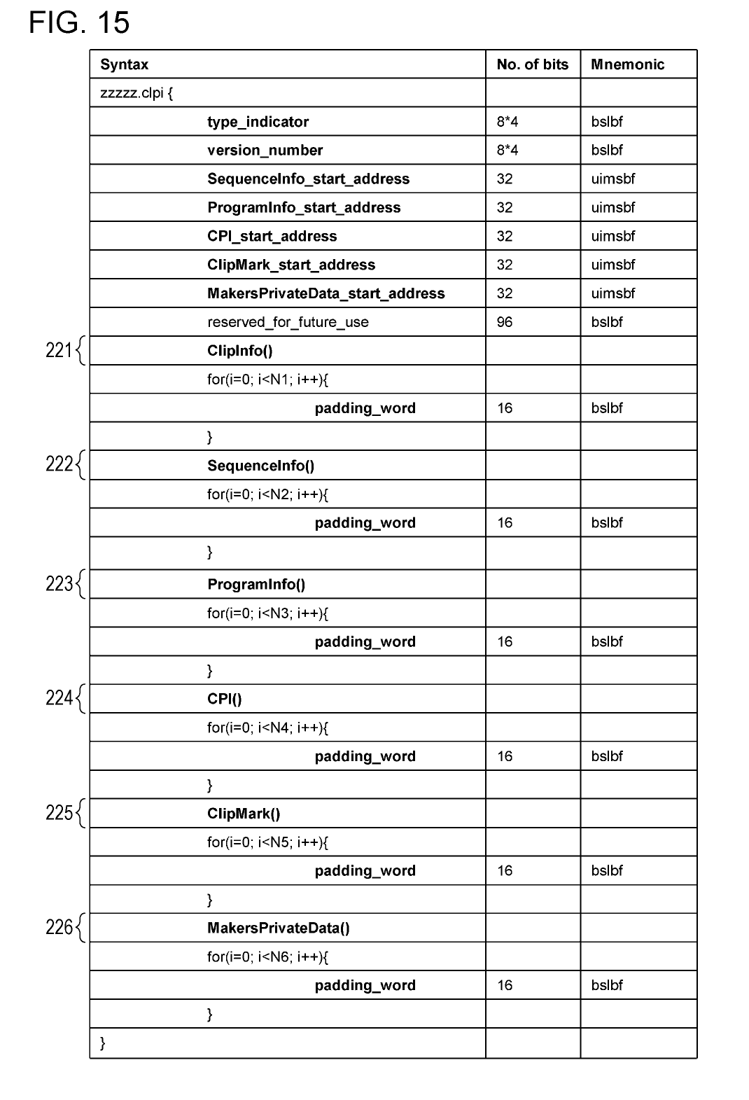

Next, a clip information file and an EP map in the clip information file used as reproduction control information of multi-angle content will be described with reference to FIG. 15 and succeeding drawings. The EP map holds the correspondence information between a PTS (Presentation Time Stamp) as a reproduction time of an angle change point and a SPN (Source Packet Number) indicating a packet location as briefly described before with reference to FIG. 12.

Furthermore, the EP map is registered not only with PTS/SPN correspondence data for the angle change point of multi-angle content but also with PTS/SPN correspondence data for the packet location to which random access can be allowed.

The syntax of the clip information file is shown in FIG. 15. The clip information file is constituted by six objects as shown in FIG. 15. They are: Clipinfo( ) 221; SequenceInfo( ) 222; ProgramInfo( ) 223; CPI( ) 224; ClipMark( ) 225; and MakersPrivateData( ) 226.

The ClipInfo( ) 221 is recorded with attribute information of an AV stream file corresponding to the clip information file.

The SequenceInfo( ) 222 will be described.

A time segment not containing a discontinuous point (discontinuous point of the system time base) of STC (System Time Clock (reference time)) in MPEG-2 transport stream is called STC_sequence, and the STC_sequence is specified by a value of stc_id in Clip. The value of the same STC in the same STC_sequence does not appear at all. Accordingly, the value of the same PTS (Presentation Time Stamp (time information for synchronized reproduction)) in the same STC_sequence also does not appear at all. When the AV stream contains N number (N>0) of STC discontinuous points, the system time base of Clip is divided into (N+1) number of STC_sequence.

The SequenceInfo is recorded with the address of a place where discontinuity of STC (discontinuity of the system time base) occurs.

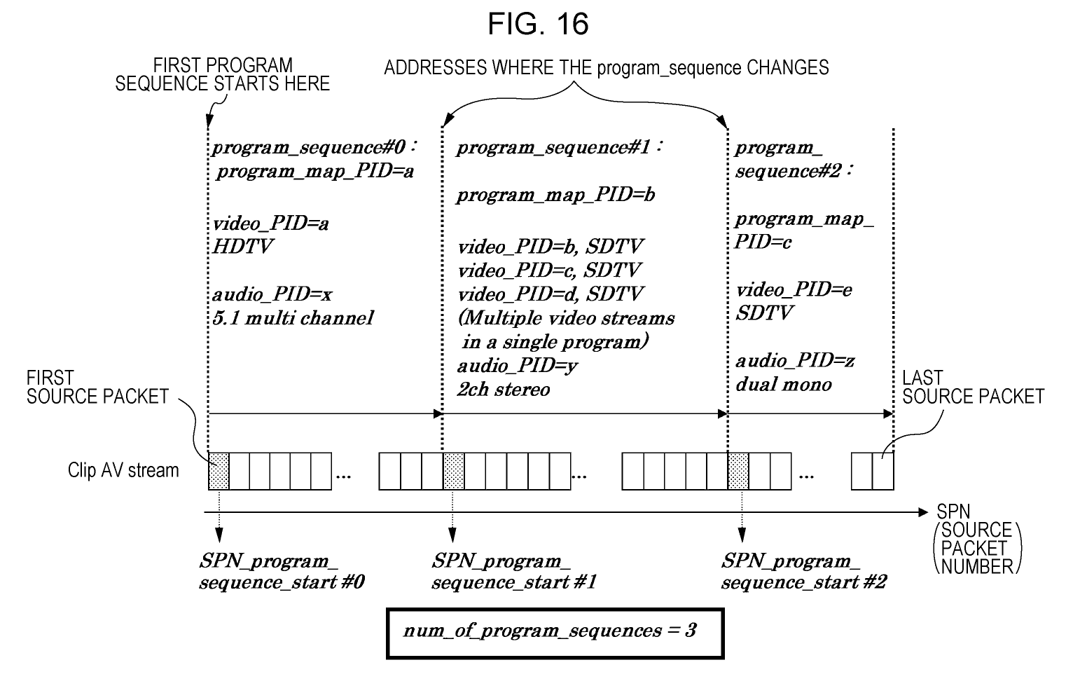

The ProgramInfo( ) 223 will be described with reference to FIG. 16.

The ProgramInfo( ) is recorded with the address of a place where the program sequence (program_sequence) starts. SPN_program_sequence_start indicates the address. The SPN is a source packet number.

Furthermore, the program sequence (program_sequence) holds the following characteristics as a reproduction segment reproduced by the clip information file and a time segment.

The value of PCR_PID (Program Clock Reference Packet ID) does not change.

The number of video elementary stream does not change.

The value of the PID of each video stream and encoding information defined by VideoCodingInfo thereof do not change.

The number of audio elementary stream does not change.

The value of the PID of each audio stream and encoding information defined by AudioCodingInfo thereof do not change.

The program sequence (program sequence) holds only one system time base at the same time point, and holds only one PMT (Program Map Table) at the same time point.

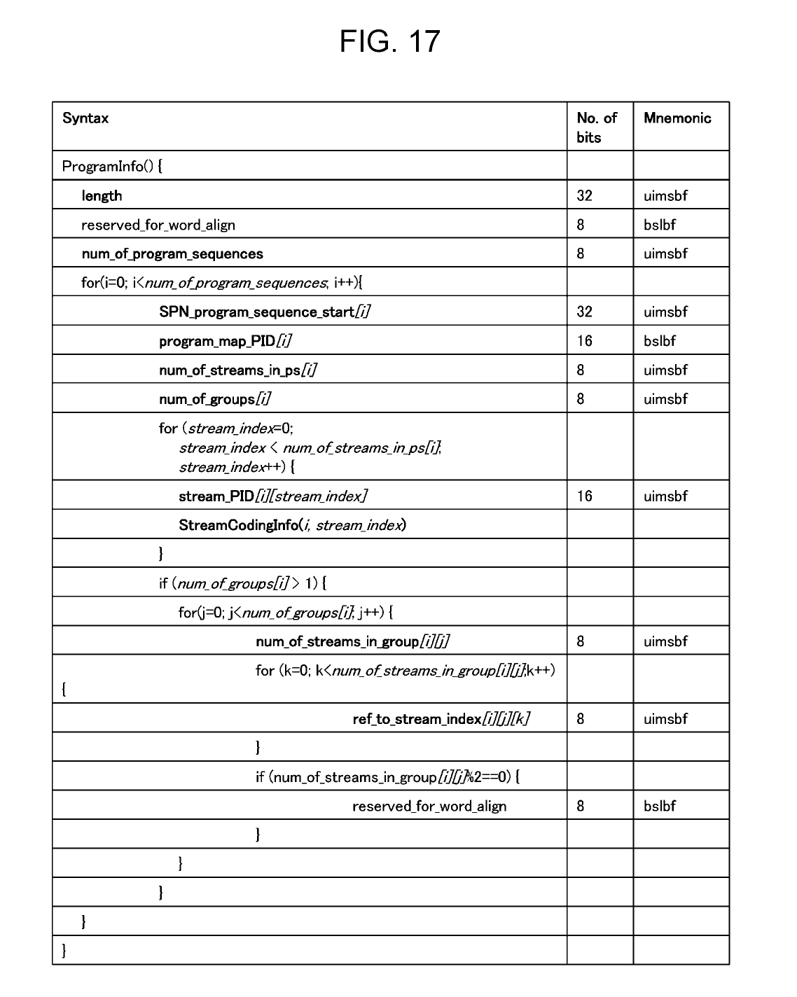

FIG. 17 shows the syntax of the ProgramInfo.

num_of_program_sequences indicates the number of program sequences (program_sequence) in the clip information file.

SPN_program_sequence_start[i] is the relative address of the place where the program sequence starts in the AV stream file.

program_map_PID[i] indicates a valid PID of a PMT in the program sequence (program_sequence). num_of_streams_in_ps[i] indicates the number of streams present in the program sequence (program_sequence).

num_of_groups[i] indicates the number of stream combinations when the program sequence (program_sequence) is reproduced.

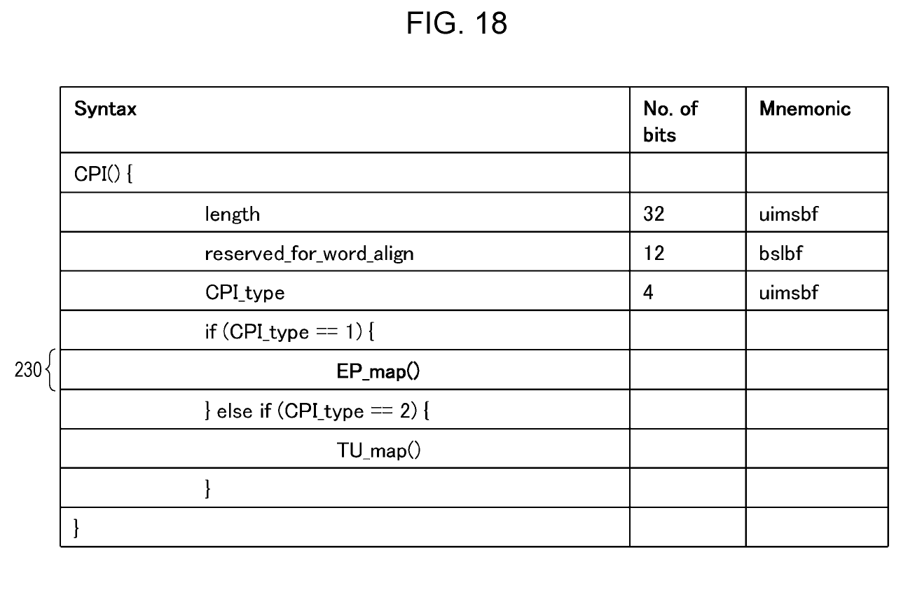

Next, the CPI (Characteristic Point Information) 224 in the syntax shown in FIG. 15 will be described. FIG. 18 is a drawing showing the syntax of the CPI.

The CPI is recorded with data for associating the time information in the AV stream with the address in the file. Specifically, the CPI is recorded with the entry point map (EP map (EP_map)) 230 previously described with reference to FIG. 12.

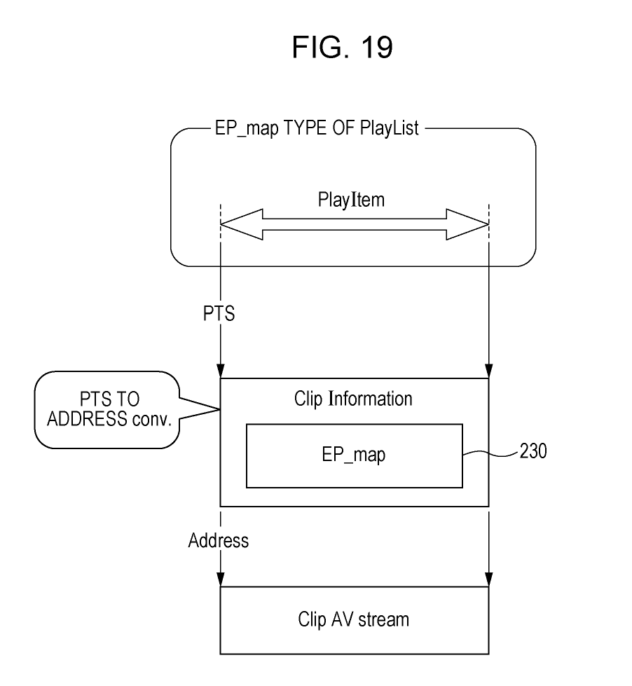

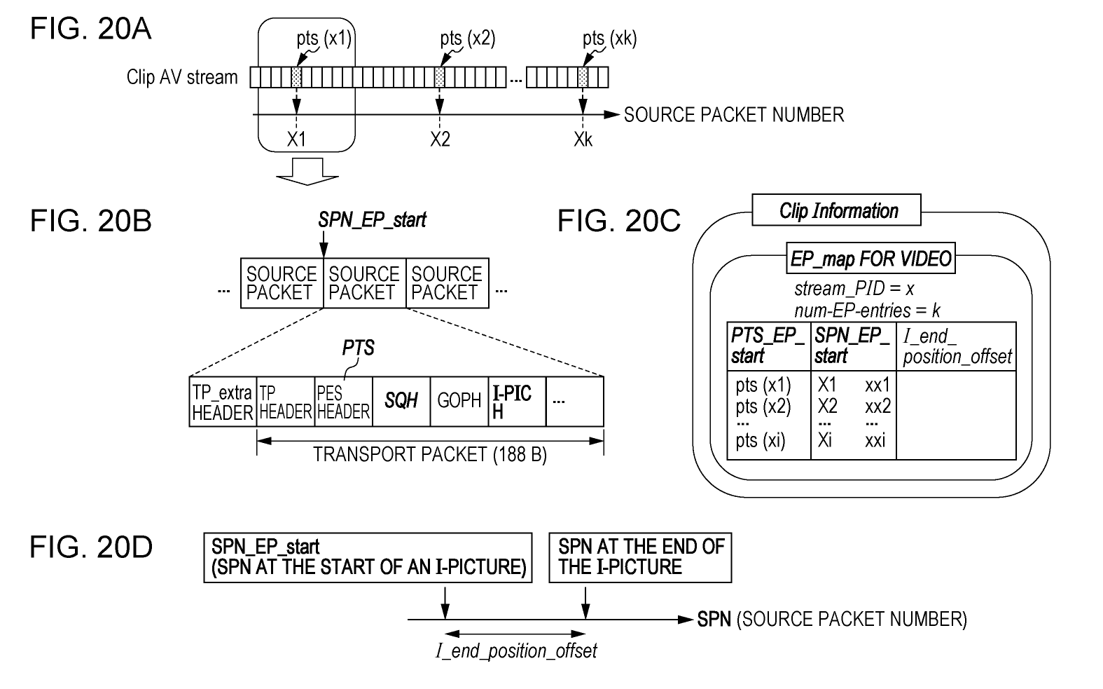

The EP map 230 will be described with reference to FIGS. 19 and 20. As shown in FIG. 19, the EP map (EP_map) 230 is data included in the clip information file. The EP map holds detection information of an I-picture location that is, for example, a point (entry point) to which random access can be started as reference data of MPEG data. A detection process of the I-picture location will be described with reference to FIG. 20. FIG. 20A shows the clip AV stream, and each rectangle indicates a 192-byte source packet. Each source packet is stipulated with a reproduction process time set with a time stamp.

FIG. 20B shows the detailed configuration of a source packet No. (X1). One source packet is constituted by a TP_extra header and a transport packet, and the transport packet includes various header information (a sequence header (SQH), a GOP header (GOPH), or the like), and substance data (IBP-picture) of MPEG data.

The clip information file shown in FIG. 20C includes the EP map as described above. The EP map includes each data pieces of [PTS_EP_start], [SPN_EP_start], and [I_end_position_offset] as shown in the drawing. The meaning of each data piece is as follows:

PTS_EP_start: Time stamp corresponding to a source packet including a sequence header (presentation time stamp);

SPN_EP_start: Leading address of a source packet including a sequence header; and

I_end_position_offset: Offset of a source packet including the end of an I-picture by a source packet including a sequence header.

FIG. 20D shows the data relationship.

In other words, the configuration of data included in a source packet is stipulated as shown in FIG. 20B, each data piece of [PTS_EP_start], [SPN_EP_start], and [I_end_position_offset] shown in FIG. 20C is obtained from the EP map, and the I-picture location in the source packet is obtained based on the data. A reproduction apparatus can perform a reproduction process from an arbitrary location by obtaining the location of the I-picture from the EP map.

The reproduction apparatus acquires the EP map from the clip information file designated by a playitem of a change destination according to, for example, a request of an angle change from a user. Furthermore, with reference to the acquired EP map, a packet location (SPN) of the leading packet of the angle change point of the clip information file of the angle change destination is acquired. Furthermore, a packet of the angle change point is acquired from the clip information file according to the acquired packet location information (SPN), and decoding and reproduction are executed. The packet of the angle change point is a packet set its leading part to a closed GOP of an I-picture, and decoding and reproduction are swiftly performed without referring to another GOP.

As such, content that is the copy source (for example, MPEG-2 encoded data) is set to data having the following constraints because the data is set to be subject to an angle change process without delay.

(A) The leading picture of the packet of the angle change point of the clip AV stream file is assumed to be the closed GOP set with the I-picture.

(B) A source packet number (SPN) indicating a packet location of an angle change point is registered in an EP map of a clip information file in correspondence with reproduction time information (PTS: Presentation Time Stamp).

### [5. Regarding Copy Process Accompanying Data Conversion Process (Transcoding) Executed by Information Processing Apparatus of Present Disclosure]

The information processing apparatus of the present disclosure performs data conversion in a data conversion process (transcoding) executed in a content copy process without losing a reproduction process function of content that is the copy source, and can execute the same reproduction process for the copied content as for the copy source content.

Specifically, for example, data conversion is executed maintaining the above-described constraints (A) and (B), and when the copied content is reproduced from the second medium as the copy destination, the same angle change as in the reproduction of the original content from the first medium that is the copy source is possible.

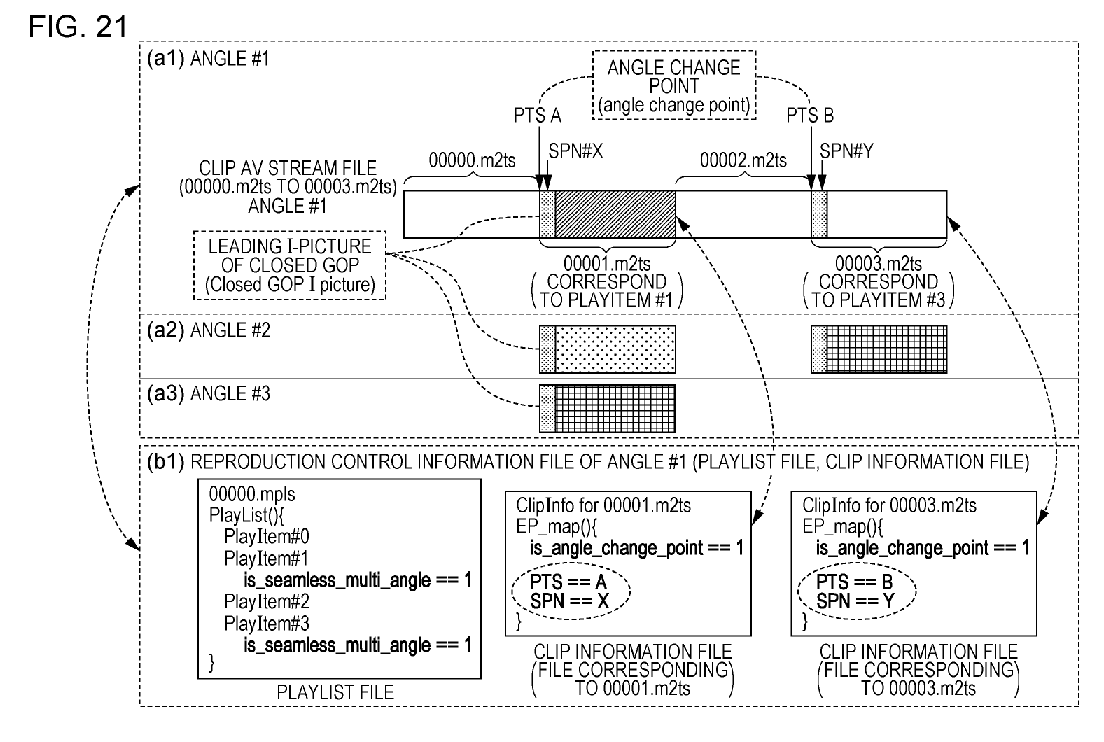

The details of a content copy process executed by the information processing apparatus of the disclosure will be described with reference to FIG. 21 and succeeding drawings.

FIG. 21 is a drawing organizing the clip AV stream file of multi-angle content that is the copy source and the correspondence relationship between the playlist file and the clip information file as control information files.

FIG. 21 shows the following data;
(a1) A part of the clip AV stream file #1 corresponding to the angle #1;
(a2) A part of the clip AV stream file #2 corresponding to the angle #2;
(a3) A part of the clip AV stream file #3 corresponding to the angle #3; and
(b1) The playlist file and the clip information file as reproduction control information files corresponding to the above-described (a1) clip AV stream file #1 corresponding to the angle #1 (including the EP map).

The clip AV stream file #1 corresponding to the angle #1 shown in (a1) has stream data (00000.m2ts to 00003.m2ts) corresponding to a plurality of playitems.

Each piece of the clip AV stream data (00000.m2ts to 00003.m2ts) is stream data designated by PlayItems #0 to #3 recorded in the playlist file shown in (b1).

Clip information files corresponding to the clip AV stream data (00000.m2ts to 00003.m2ts) are selected by the PlayItems #0 to #3 recorded in the playlist file shown in (b1), and the clip AV stream data (00000.m2ts to 00003.m2ts) corresponding to the clip information files are acquired and reproduced.

(b1) of FIG. 21 shows the clip information files corresponding to two pieces of the stream data (00001.m2ts and 00003.m2ts) shown in (a1).

These two pieces of the stream data (00001.m2ts and 00003.m2ts) are data for multi-angle.

Whether data is for multi-angle or not can be determined with reference to playitem information of a playlist file (is_seamless_multi_angle), information included in the EP map of the clip information file (is_angle_change_point), or flag setting thereof. When the flag of the information is set to one, data acquired by the playitem or data acquired by data for PTS/SPN of the EP map of the clip information file is data for multi-angle. When the flag is set to zero, such data is not data for multi-angle.

In the example shown in FIG. 21, two pieces of the stream data (00001.m2ts and 00003.m2ts) are data for multi-angle.

Such a data reproduction segment is set with stream data of three angles of the (a2) angle #2 and (a3) angle #3 shown in the drawing in addition to the angle #1, and a user can select any angle data from three angles of the angles #1 to #3 for reproduction.

Furthermore, FIG. 21 shows only the control information file corresponding to the angle #1 in (b1) thereof, but control information files corresponding to the stream data of (a2) angle #2 and the stream data of (a3) angle #3 (playlist file and clip information file) are also present respectively.

When the stream data of (a2) angle #2 is to be reproduced, reproduction is executed using the playlist file and clip information file corresponding to the stream data of the angle #2.

When the stream data of (a3) angle #3 is to be reproduced, reproduction is executed using the playlist file and clip information file corresponding to the stream data of the angle #3.

When the stream data of (a1) angle #1 is to be reproduced, reproduction is executed using the playlist file and clip information file corresponding to the stream data of the angle #1, in other words, the playlist file and clip information file shown in (b1) of FIG. 21.

When the stream data 00001.m2ts shown in (a1) of FIG. 21 is to be reproduced, for example, the clip information file (ClipInfo for 00001.m2ts) shown in the center of (b1) of FIG. 21 is acquired according to clip designation information recorded in playitem information (PlayItem #1) recorded in the playlist file shown in (b1) of FIG. 21, a PTS as reproduction time information and an SPN indicating a packet location are acquired with reference to the EP map of the clip information file, and packets are acquired from the clip AV stream according to the SPN, thereby executing a reproduction process of the angle #1.

In the example shown in FIG. 21, packets from the leading part to X-th of the stream file are acquired in accordance with an SPN #X for reproduction.

When the stream data 00003.m2ts shown in (a1) of FIG. 21 is to be reproduced, the clip information file (ClipInfo for 00003.m2ts) shown in the right end of (b1) of FIG. 21 is acquired according to clip designation information recorded in playitem information (PlayItem #3) recorded in the playlist file shown in (b1) of FIG. 21, a PTS as reproduction time information and an SPN indicating a packet location are acquired with reference to the EP map of the clip information file, and packets are acquired from the clip AV stream according to the SPN, thereby executing a reproduction process of the angle #3.

In the example shown in FIG. 21, packets from the leading part to Y-th of the stream file are acquired in accordance with an SPN #Y for reproduction.

Furthermore, the packets acquired according to the SPN #X and SPN #Y includes a closed GOP (Closed GOP) with an I-picture set as the leading picture, and swift decoding and reproduction are realized by the decoding of the closed GOP without referring to another GOP.

As described with reference to FIG. 21, the content recorded on the first medium that is the copy source is set satisfying the following constraints.

(A) The leading picture of the packet of the angle change point of the clip AV stream file is assumed to be the closed GOP set with the I-picture.

(B) A source packet number (SPN) indicating a packet location of an angle change point is registered in an EP map of a clip information file in correspondence with reproduction time information (PTS: Presentation Time Stamp).

However, there is a possibility of not maintaining those constraints if the data conversion unit (transcoder) executes a conversion process to copy the data on the second medium.

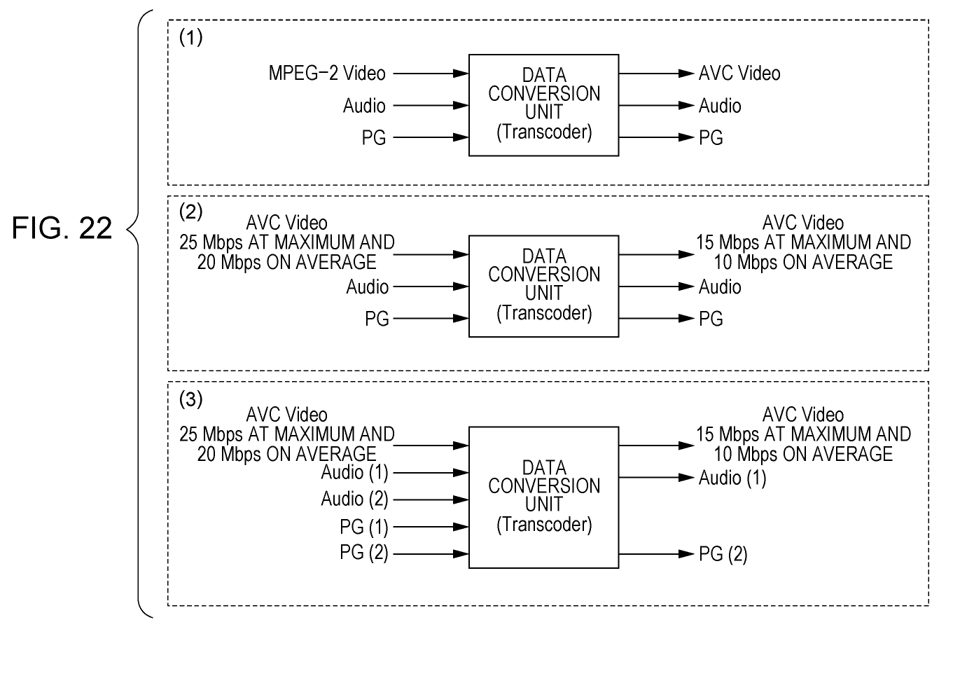

There are data conversion processes, as shown in FIG. 22, executed by the data conversion unit (transcoder):

(1) Conversion of encoding format;

(2) Conversion of video compression rate; and

(3) Elimination of stream.

(1) Conversion of encoding format is applied to a case where the encoding format of the copy source data stored in the first medium is, for example, MPEG-2, and the encoding format of the data recorded on the second medium that is the copy destination is a different encoding format such as AVCHD, or the like.

Furthermore, the Video shown in FIG. 22 refers to a video stream, Audio refers to an audio stream, and PG refers to a presentation graphics data stream, for example, subtitle data, or the like.

An example of (2) conversion of video compression rate is a case where the encoding formats of both copy source data stored in the first medium and data recorded on the second medium as the copy destination are the same, for example, the AVCHD format but the compression rate is changed.

Specifically, the copy source data is composed of video stream data with 25 Mbps at maximum and 20 Mbps on average, but the setting is lowered to 15 Mbps at maximum and 10 Mbps on average for the copy destination data. This corresponds to a process in which copied data with little reduced image quality is generated and recorded.

(3) Elimination of a stream is a process in which a stream that is set to a non-copy target is eliminated.

As shown in (3) of FIG. 22, the copy source data stored on the first medium is constituted by the following stream data such as:

one video stream (Video);

two audio streams (Audio(1) and Audio(2)); and

two presentation graphics data streams (PG(1) and PG(2)).

On the other hand, data recorded on the second medium as the copy destination includes only:

one video stream (Video);

one audio stream (Audio(1)); and

one presentation graphics data stream (PG(2)).

Other streams (Audio(2) and PG(1)) are deleted without being set to copy targets.

As a data conversion process executed by the data conversion unit (transcoder) during a copy process, there are (1) conversion of encoding scheme, (2) conversion of video compression rate, and (3) elimination of stream as shown in FIG. 22. Furthermore, there is a case where processes of (1) to (3) are arbitrarily combined for execution.

If such data conversion is executed, the data packet configurations of copy source data and copy destination data are different as a result.

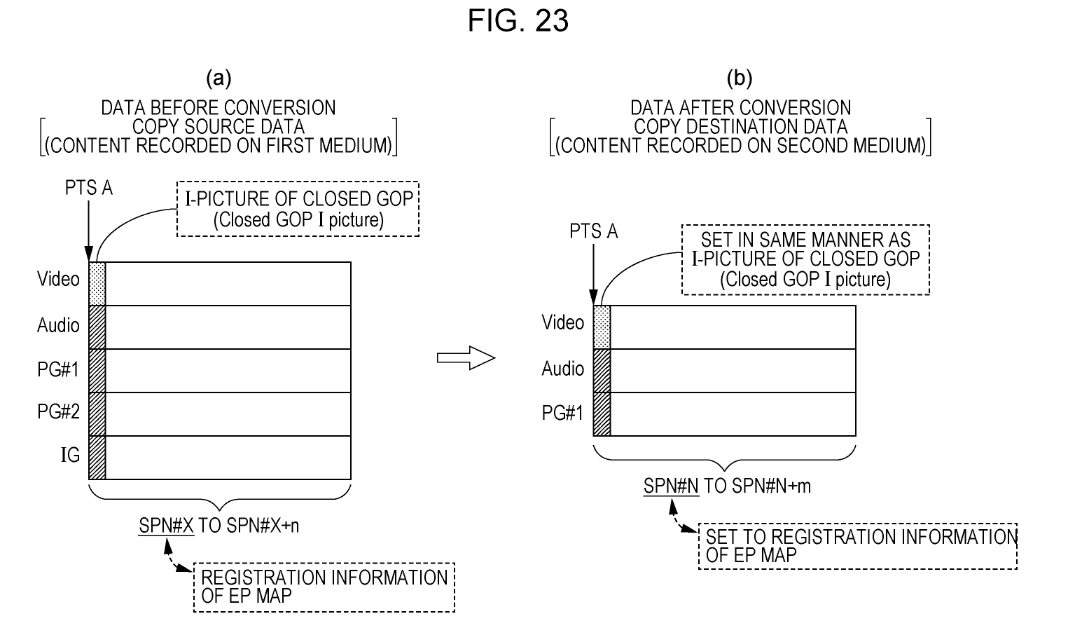

The specific example will be described with reference to FIG. 23. FIG. 23 shows following two data examples.

(a) Data before conversion (copy source data (content recorded on the first medium))

(b) Data after conversion (copy destination data (content recorded on the second medium))

(a) Data before conversion (copy source data (content recorded on the first medium)) shown in Fig. (A) of 23 corresponds to the detailed configuration of, for example, the stream data (00001.m2ts) in the clip AV stream #1 of the multi-angle content shown in FIG. 21.

The result of the conversion of the stream data (00001.m2ts) in the copy process is (b) data after conversion (copy destination data (content recorded on the second medium)), and corresponds to data recorded as copied data on the second medium.

The (a) data before conversion (copy source data (content recorded on the first medium)) is constituted by the following stream data, which includes:

one video stream (Video);

one audio stream (Audio);

two presentation graphics data stream (PG #1 and PG #2); and

one interactive graphics (IG).

Furthermore, the interactive graphics (IG) is graphics data for displaying, for example, a switch, a button, or the like providing a user interface.

On the other hand, the (b) data after conversion (copy destination data (content recorded on the second medium)) shown in (B) of FIG. 23 is constituted by the following stream data, which includes:

one video stream (Video);

one audio stream (Audio); and

one presentation graphics data stream (PG #1).

Furthermore, there is a case where also the encoding formats of (a) data before conversion and (b) data after conversion are different.

Since the (a) data before conversion and the (b) data after conversion include different constituent data, the number of packets is also different.

In the example shown in the drawing, the source packet number (SPN) of the (a) data before conversion is constituted by n number packets of SPN #X to SPN #X+n.

On the other hand, the source packet number (SPN) of the (b) data after conversion is constituted by m number packets of SPN #N to SPN #N+m.

The change in the packet configuration occurs not only in stream data (00001.m2ts) in the clip AV stream #1 shown in (a) of FIG. 21 but also in all data.

Thus, the leading source packet number (SPN) of the angle change point also changes. In the example of FIG. 23, the SPN #X is changed to the SPN #N.

The source packet number (SPN #X) of the angle change point of the (a) data before conversion is an SPN registered in the EP map as described before.

If the packet configuration is changed by data conversion, the SPN of the angle change point of the (b) data after conversion in the example shown in FIG. 23 is changed to the SPN #N. Thus, if the SPN #X registered in the EP map is applied without change, packets at a location totally different from the SPN #N of the angle change point of the (b) data after conversion are acquired.

In addition, the packets of the angle change point of the (a) data before conversion are set as packets having a closed GOP including an I-picture as the leading picture. Furthermore, the packet configuration includes a sequence header (SQH) or a GOP header (GOPH) as previously described with reference to FIG. 20B, and further includes packets constituted by a closed GOP or the like including the leading I-picture.

Such a packet setting is not maintained by data conversion executed in a copy process all the time.

If the setting of a closed GOP is changed, a reference process to pictures of another GOP has to be performed during image reproduction of an angle change point, and therefore, there is a concern that an angle change may not be smoothly executed.

The information processing apparatus of the present disclosure executes a data conversion process in which such an incident is prevented.

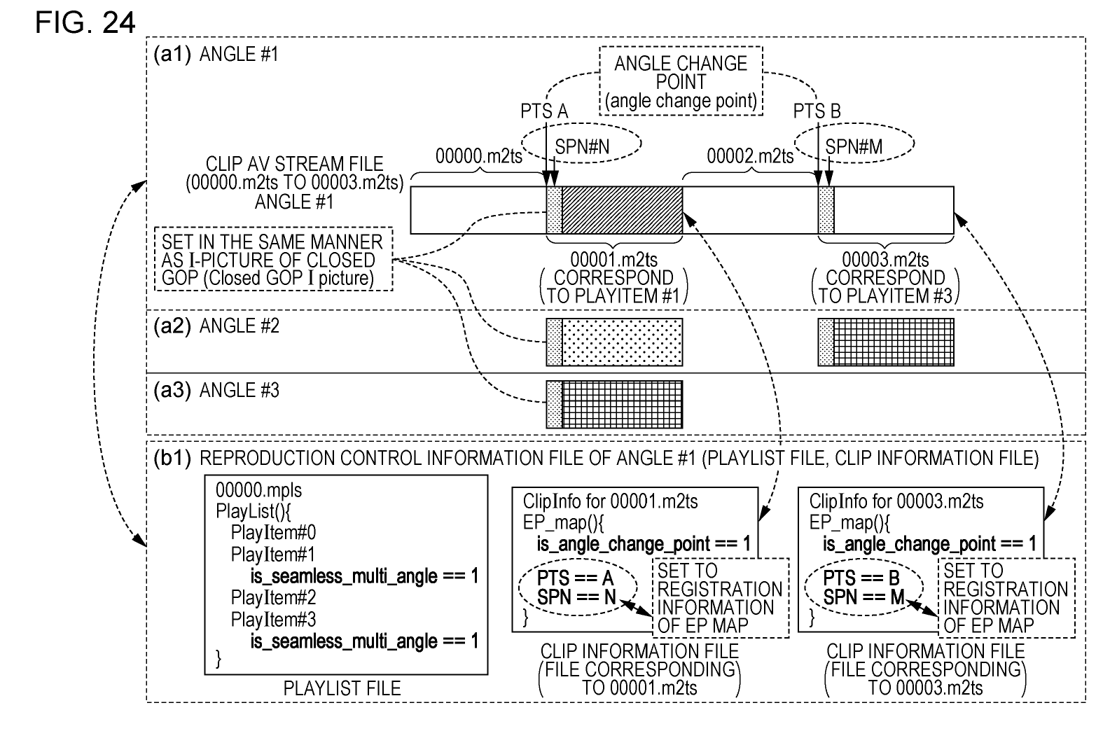

A setting example of data stream (clip Av stream file) generated by data conversion executed by the information processing apparatus of the disclosure and the control information files (playlist file and clip information file) will be described with reference to FIG. 24.

FIG. 24 shows the following data same as FIG. 21.
(a1) A part of the clip AV stream file #1 corresponding to the angle #1;
(a2) A part of the clip AV stream file #2 corresponding to the angle #2;
(a3) A part of the clip AV stream file #3 corresponding to the angle #3; and
(b1) The playlist file and the clip information file as reproduction control information files corresponding to the above-described (a1) clip AV stream file #1 corresponding to the angle #1 (including the EP map).

The data is data after conversion (copy destination data) obtained after the data conversion unit (transcoder) executes a conversion process for the data before conversion (copy source data) shown in FIG. 21.

The clip AV stream file #1 corresponding to the angle #1 shown in (a1) has stream data (00000.m2ts to 00003.m2ts) corresponding to a plurality of playitems.

Each piece of the clip AV stream data (00000.m2ts to 00003.m2ts) is stream data designated by PlayItems #0 to #3 recorded in the playlist file shown in (b1).

A clip information file corresponding to the clip AV stream data (00000.m2ts to 00003.m2ts) is selected by the PlayItems #0 to #3 recorded in the playlist file shown in (b1), and the clip AV stream data (00000.m2ts to 00003.m2ts) corresponding to the clip information file is acquired for reproduction.

(b1) of FIG. 24 shows the clip information file corresponding to two pieces of stream data (00001.m2ts and 00003.m2ts) shown in (a1).

Those two pieces of stream data (00001.m2ts and 00003.m2ts) are data for multi-angle.

Whether the data is for multi-angle or not can be determined with reference to playitem information of a playlist file (is_seamless_multi_angle), information included in the EP map of the clip information file (is_angle_change_point), or flag setting thereof. When the flag of the information is set to one, data acquired by the playitem or data acquired by data for PTS/SPN of the EP map of the clip information file is data for multi-angle. When the flag is set to zero, such data is not data for multi-angle.

In the example shown in FIG. 24, two pieces of the stream data (00001.m2ts and 00003.m2ts) are data for multi-angle.

Such a data reproduction segment is set with stream data of three angles of the (a2) angle #2 and (a3) angle #3 shown in the drawing in addition to the angle #1, and a user can select any angle data from three angles of the angles #1 to #3 for reproduction.

Furthermore, FIG. 24 shows only the control information file corresponding to the angle #1 in (b1) thereof in the same manner as FIG. 21, but control information files corresponding to the stream data of (a2) angle #2 and the stream data of (a3) angle #3 (playlist file and clip information file) are also present respectively.

When the stream data of (a2) angle #2 is to be reproduced, reproduction is executed using the playlist file and clip information file corresponding to the stream data of the angle #2.

When the stream data of (a3) angle #3 is to be reproduced, reproduction is executed using the playlist file and clip information file corresponding to the stream data of the angle #3.

When the stream data of (a1) angle #1 is to be reproduced, reproduction is executed using the playlist file and clip information file corresponding to the stream data of the angle #1, in other words, the playlist file and clip information file shown in (b1) of FIG. 24.

Those settings are the same as the setting of the data before conversion shown in FIG. 21.

Since it is possible to smoothly perform an angle change even after the conversion process, the information processing apparatus of the disclosure executes a process of changing registration information of the EP map of the clip information file to a source packet number (SPN) of an angle change point.

For example, the packet number in the leading part of the stream data 00001.m2ts that is multi-angle content shown in (a1) of FIG. 24 is changed from an SPN #X in the setting shown in FIG. 21 to an SPN #N.

A data processing unit of the information processing apparatus of the disclosure changes registration information of the EP map of the clip information file corresponding to the stream data 00001.m2ts in accordance with the change in the SPN of the packet in the leading part of the stream data 00001.m2ts.

The data processing unit of the information processing apparatus of the disclosure acquires location information of the packet corresponding to the angle change point based on the converted data generated by the data conversion unit, and executes an updating process of the reproduction control information file in which angle change point location information of data before conversion recorded on the EP map of the reproduction control information file (clip information file) included in data to be copied is changed to angle change point location information of data after conversion. In other words, a process of re-writing SPN=X that is registration information of the EP map recorded in the clip information file shown in the center of (b1) of FIG. 24 into SPN=N is performed.

Furthermore, the PTS (Presentation Time Stamp) that is reproduction time information is the same both before and after conversion, and thus is not changed.

Furthermore, for the source packet number (SPN) of the angle change point, for example, the number of packets may be counted and calculated from the leading packet of constituent data of clip AV stream after conversion, and may be calculated based on the number of bytes from the leading part of the constituent data of the clip AV stream after conversion. One packet is 192 bytes, the number of preceding packets can be calculated by dividing the number of bytes from the leading part of the AV stream file to the angle change point by 192 bytes, and the packet number (SPN) of the angle change point is the number of preceding packets+1.

The information processing apparatus of the disclosure further performs a process of setting a GOP of the packet set on the angle change point to data equivalent to a closed GOP of which the leading part is set to an I-picture.

In other words, the process is set to be able to decode and reproduce a series of moving images with reference only to specific picture sets.

The concept of a GOP is applied to the MPEG-2 format, but not applied to, for example, the MPEG-4 AVC and the AVCHD format.

For example, the AVC format that includes the MPEG-4 AVC and AVCHD format is stipulated with an IDR (Instantaneous Decoder Refresh) picture having the same setting as that of the leading I-picture of a closed GOP.

The IDR picture is a picture which enables decoding of all pictures after the IDR picture without reference to pictures before the IDR picture. In other words, when the IDR picture is set to a reproduction start picture, decoding and reproduction can be executed without reference to pictures before the IDR picture.

The data conversion unit of the information processing apparatus of the disclosure executes an encoding process by setting the leading I-picture of a closed GOP (Closed GOP) in a packet of an angle change point to an IDR picture in the AVC format when, for example, copy source data is MPEG-2 formatted data and copied data after conversion is in the AVC format including the MPEG-4 AVC, the AVCHD format, or the like.

By performing the process, when reproduction is performed from the angle change point, an accurate decoding and reproduction process can be performed for images after the IDR picture only using pictures after the IDR picture having the IDR picture set in the angle change point as a reproduction start picture.

In other words, a process in which the IDR picture in the AVC format is set to the reproduction start point can perform the same process of executing decoding and reproduction having the leading I-picture of the closed GOP in the MPEG-2 format as the reproduction start point.

Furthermore, a data conversion process not accompanying a change in the encoding format, for example, (2) conversion of video compression rate and (3) elimination of stream described with reference to FIG. 22 is to be executed maintaining the MPEG-2 format, data conversion is executed without changing the setting of the closed GOP that has the leading I-picture of the angle change point before and after the conversion, but maintaining the setting.

In the same manner, when the original data that is the copy target and is recorded on the first medium is, for example, the AVC formatted data including MPEG-4 AVC, the AVCHD format, or the like, and (2) conversion of video compression rate and (3) elimination of stream described with reference to FIG. 22 is to be executed maintaining the format, data conversion is executed without changing the setting of the IDR picture of the angle change point before and after the conversion, but maintaining the setting of the IDR picture.

By executing the data conversion, even when copied data is reproduced from the second medium that is the copy destination, the reproduction from the leading picture of the angle change point can be smoothly performed.

### [6. Regarding Sequence of Copy Process Executed by Information Processing Apparatus of Present Disclosure]

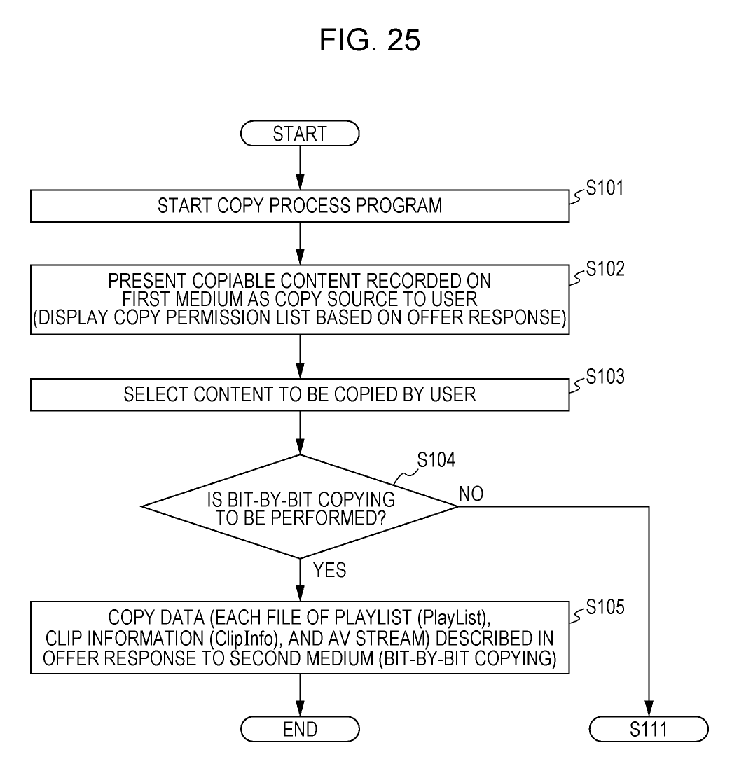

Next, the sequence of the copy process executed by the information processing apparatus of the disclosure will be described with reference to the flowcharts shown in FIG. 25 and succeeding drawings.

The flowchart shown in FIG. 25 illustrates a process of each of Step S101 and succeeding steps. Furthermore, the process of each step shown in the flow is executed in the data conversion unit (transcoder) or the data processing unit of the information processing apparatus. The data processing unit mainly analyzes data that is the conversion target, and the data conversion unit (transcoder) executes a data conversion process according to the analysis result.

First, in Step S101, a copy processing program stored in the information processing apparatus in advance is started.

Furthermore, the copy process is performed as the managed copy (MC) process executed under the management of the server previously described with reference to FIG. 4.

In Step S102, copyable content recorded on the first medium that stores copy source content is displayed to a user. The display process is performed using a display unit (display) of the information processing apparatus.

The process is equivalent to a process of displaying a list of copy permitted content (copy permission list 121) on the display unit of the information processing apparatus with application of the response information (Offer Response) 131 from the management server 140 previously described with reference to FIGS. 4 and 7. The list is set with, for example, a fee (price) for copying each piece of content.

In Step S103, content to be the copy target is selected from the displayed list.

In Step S104, it is determined whether or not bit-by-bit (Bit by Bit) copy for copying data recorded on the first medium without change, in other words, a copy process not accompanying data conversion (transcoding) is to be performed. The determination may be made based on a user's input, or may be made according to information stipulated for the apparatus in advance.

When the bit-by-bit copy process not accompanying data conversion is to be executed, the process advances to Step S105, and a process is performed in which each of a playlist file (PlayList) to be copied, a clip information file (ClipInfo) designated from the selected playlist, and a clip AV stream file (m2ts) is read from the first medium according to the playlist file name described in the response information (Offer Response) received from the server (refer to FIG. 7) and copying on the second medium is performed.

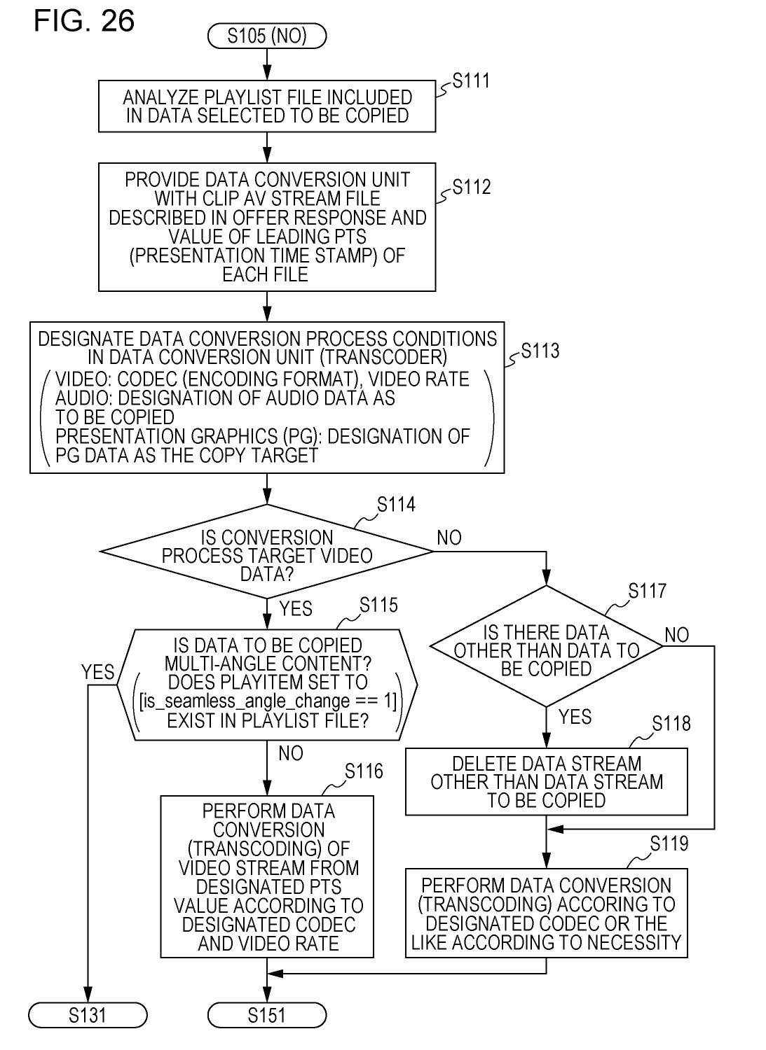

On the other hand, in Step S104, when it is determined to perform a copy process accompanying data conversion (transcoding) not the bit-by-bit (Bit by Bit) copy which is copying data recorded on the first medium without change, the process advances to Step S111 of FIG. 26.

In Step S111, the playlist file included in the data to be copied selected by the user is analyzed. Furthermore, when there is a plurality of playlist files included in the data to be copied, the process of Step S111 and succeeding steps is sequentially executed for each of the playlist files.

In Step S112, a clip information file designated by the playlist file (PlayList) to be copied and a clip AV stream file that is reproduction data are acquired according to the playlist file name described in the response information (Offer Response) received from the server (refer to FIG. 7), and the initial PTS (Presentation Time Stamp) of the clip AV stream is acquired to be provided to the data conversion unit (transcoder).

Next, in Step S113, data conversion processing conditions are designated in the data conversion unit (transcoder). Specifically, for example, the following conditions are designated.

Video: Codec (encoding format) and video rate

Audio: Designation of audio data to be copied

Presentation graphics (PG): Designation of PG data as the copy target

The designation may be executed by a user's input, or may use default designation conditions stipulated in advance in the information processing apparatus.

Furthermore, the data conversion process executed by the data conversion unit (transcoder) is executed as a process of any of, or a combination of, the following operations as previously described with reference to FIG. 22, which are:

(1) Conversion of encoding format;

(2) Conversion of video compression rate; and

(3) Elimination of stream.

In Step S114, data that is the data conversion processing target is sequentially selected, and it is determined whether or not the data to be the conversion processing target is video data. Furthermore, the data conversion unit (transcoder) executes data conversion in a predetermined data unit. The conversion processing target data includes video data, audio data, PG (Presentation Graphics) data such as subtitles, and the like.

When the conversion processing target is video data, the process advances to Step S115.

In Step S115, it is determined whether or not the video data that is the conversion processing target is multi-angle content. The determination process is executed with reference to, for example, playitem information of the playlist file or the clip information file.

It is determined with reference to the flag (is_seamless_multi_angle) set in the multi-angle content identification field in the playitem information of the playlist file previously described with reference to FIG. 14 and (b1) of FIG. 21. In the case of (is_seamless_multi_angle==1), the content designated in the playitem is multi-angle content.

If the video data to be converted is determined to be multi-angle content, the process advances to Step S131.

On the other hand, if the video data to be converted is determined to be not multi-angle content, the process advances to Step S116.

In Step S116, the data conversion unit executes data conversion process (transcoding) under designated encoding conditions from the leading part of the data stream designated by the PTS value provided from the data processing unit previously in Step S112 according to information such as codec (encoding mode) determined in Step S113. The data conversion process is a data conversion process for video data that is not multi-angle content. After the encoding process, the process advances to Step S151.

On the other hand, in Step S114, when the conversion processing target is determined to be not video data, the process advances to Step S117. For example, this is applied when the conversion target is audio data or PG data.

In Step S117, it is determined whether or not there is data not to be copied. For example, when the audio data includes data for Japanese, English, and the like, and the user selects only the Japanese data to be copied, the English audio data is data not to be copied.

When it is determined that there is data not to be copied in Step S117, the data not to be copied is deleted in Step S118. Furthermore, in Step S119, a data conversion process is executed only for the data to be copied according to necessity, and the process advances to Step S151.

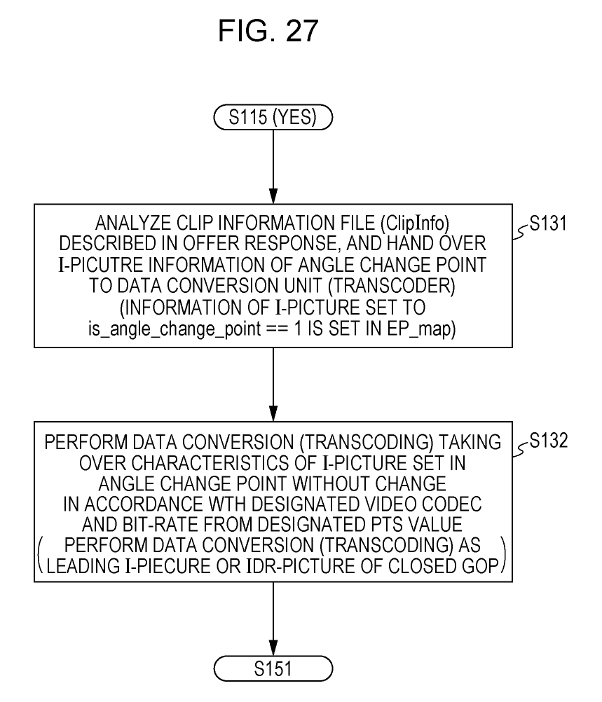

Next, a process of the case where the video data to be converted is determined to be multi-angle content in Step S115, that is, a process of Step S131 and succeeding steps will be described with reference to the flowchart shown in FIG. 27.

In Step S131, the data processing unit analyzes the clip information file (ClipInfo) designated from the playlist file (PlayList) to be copied described in the response information (Offer Response) received from the server (refer to FIG. 7), and provides I-picture information of the angle change point to the data conversion unit (transcoder).

The I-picture information of the angle change point provided to the data conversion unit (transcoder) is registration information of the EP map of the clip information file (ClipInfo).

The EP map is registered with correspondence data between a time stamp (PTS: Presentation Time Stamp) as reproduction time information in packet location information to which random access is possible and a source packet number (SPN) indicating the packet location, for example, as shown in the clip information file at the center of (b1) of FIG. 21.

Furthermore, registration information of the angle change point is set with the flag [is_angle_change_point==1] indicating to be the angle change point.

The data processing unit acquires the registration information (PTS/SPN) data set with the flag [is_angle_change_point==1] indicating it is to be the angle change point from the registration information of the EP map, and the acquired information is output to the data conversion unit (transcoder).

Step S132 is a process of the data conversion unit (transcoder). The data conversion unit executes data conversion according to information of determining the video stream of the multi-angle content that is the data conversion target in Steps S112 and S113 in Step S132.

During the data conversion process, data conversion is executed without breaking the state of the closed GOP of the leading I-picture on the angle change point.

After the data conversion, the process advances to Step S151.

Furthermore, the data conversion process in Step S132 becomes a different process depending on the executed conversion mode. Specifically, any of the following processes is performed.

(1) When MPEG-2 encoded data is converted into AVC encoded data, conversion of the leading I-picture of the closed GOP in the MPEG-2 encoded data into an IDR picture in the AVC encoded data is performed.

(2) When MPEG-2 encoded data is converted into MPEG-2 encoded data (for example, a change in the compression rate, or the like), data conversion is performed maintaining the leading I-picture of the closed GOP without change.

(3) When AVC encoded data is converted into AVC encoded data (for example, a change in the compression rate, or the like), data conversion is performed maintaining the IDR picture without change.

In other words, data conversion (transcoding) is performed setting the picture of the angle change point to the leading I-picture of the closed GOP or the IDR picture.

As such, by setting the picture of the angle change point to the leading I-picture of the closed GOP or the IDR picture, perfect decoding and reproduction are possible referring only to data of the acquired and succeeding pictures in data reproduction from the angle change point.

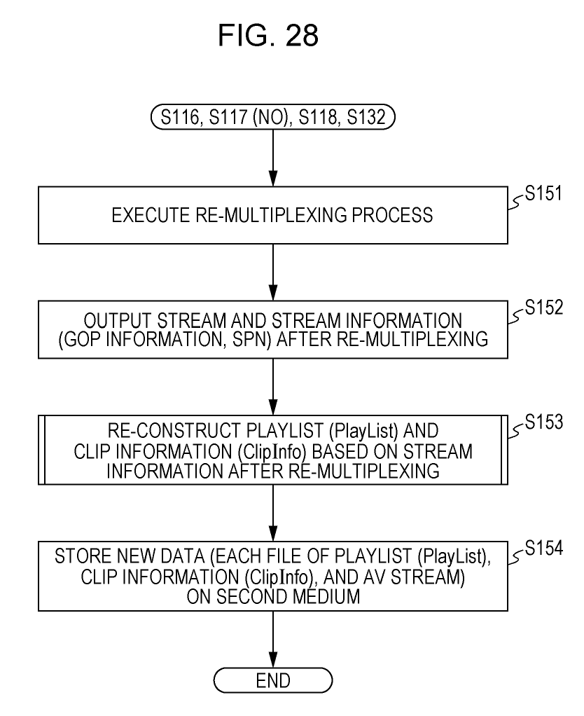

Next, a process of Step S151 and succeeding steps will be described with reference to FIG. 28.

The process of Step S151 is executed after the completion of the conversion process of video stream and audio stream selected as a copy target.

In Step S151, a re-composition process (multiplexing process or the like) of the clip AV stream only constituted by data to be copied except for deleted data is executed.

In other words, the AV stream constituted only by data selected as a copy target is re-set.

In Step S152, resetting of a GOP as encoding/decoding unit of MPEG, resetting of a source packet number (SPN), or the like is executed. The source packet number (SPN) is a number from the leading part of the packet in the clip AV stream.

Next, in Step S153, an updating process of the playlist file and the clip information file is executed based on data after the re-composition process (multiplexing process or the like) of the clip AV stream.

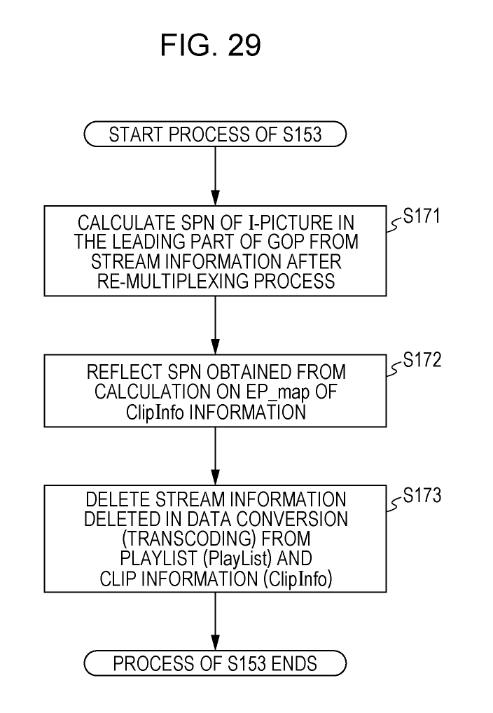

The detailed sequence of the updating process of the playlist file and the clip information file will be described with reference to the flowchart shown in FIG. 29.

In Step S171, the source packet number (SPN) of the leading I-picture of the GOP is calculated based on data after the re-composition process (multiplexing or the like) of the clip AV stream.

In Step S172, the data processing unit records the calculated source packet number (SPN) of the leading part of the GOP in the EP map (EP_map).

This process corresponds to, for example, a process previously described with reference to FIG. 24. Registration information of the EP map of the clip information file corresponding to the stream data 00001.m2ts is updated in accordance with an SPN change of the packet in the leading part of the stream data 00001.m2ts shown in FIG. 24. In other words, a process of rewriting SPN=X that is the registration information of the EP map recorded in the clip information file shown at the center of (b1) of FIG. 24 to SPN=N is performed. As such, the data processing unit of the information processing apparatus of the disclosure acquires location information of the packet corresponding to the angle change point based on the conversion data generated by the data conversion unit, and an updating process of the reproduction control information file is executed in which angle change point location information of the data before conversion recorded on the EP map of the reproduction control information file (clip information file) included in data to be copied is changed to angle change point location information of data after conversion. Furthermore, the PTS (Presentation Time Stamp) that is reproduction time information is the same before and after data conversion without change.

Furthermore, in the process described with reference to FIG. 24, an example of a process to change only an SPN value for the angle change point is described, but all SPN values registered in the EP map may be configured to be reset.

The source packet number (SPN) recorded in the EP map may be calculated, for example, by counting the number of packets from the leading packet of data constituting a clip AV stream after conversion, and may be calculated based on the number of bytes from the leading part of data constituting a clip AV stream after conversion. One packet is 192 bytes, the number of preceding packets can be calculated by dividing the number of bytes from the leading part of the AV stream file to the angle change point by 192 bytes, and the packet number (SPN) of the angle change point is the number of preceding packets+1.

By using the EP map updated as above, a reproduction apparatus for reproducing copied data after conversion can obtain a correct location of the I-picture from the updated EP map, and can execute a reproduction process from the SPN location registered in the EP map.

In Step S173, the playlist file and the clip information file are updated in order to correspond to a change of streams deleted during data conversion (transcoding).

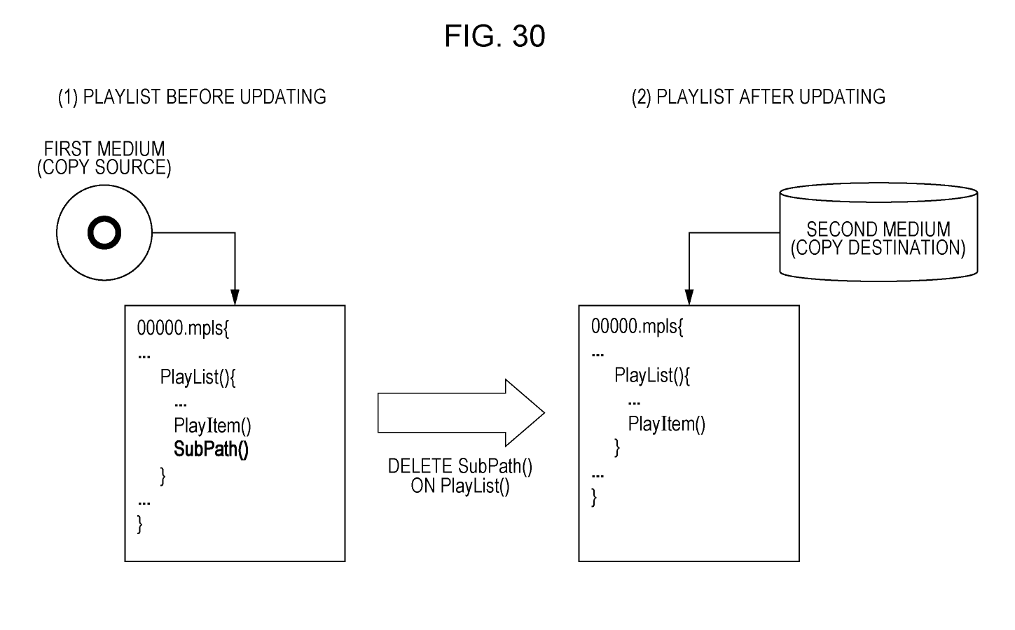

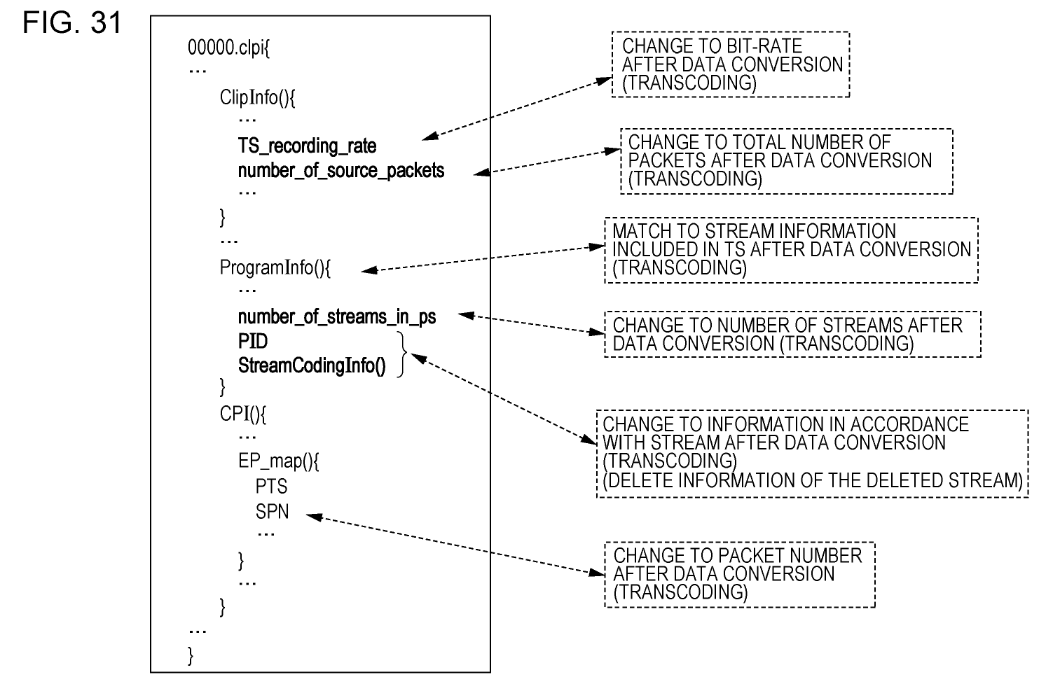

An example of the updating process of the playlist file and the clip information file will be described with reference to FIGS. 30 and 31.

FIG. 30 is a diagram showing an example of a playlist file updating process.

FIG. 31 is a diagram showing an example of a clip information file updating process.

First, the example of the playlist file updating process will be described with reference to FIG. 30.

The example shown in FIG. 30 is an example of deleting subpath information (SubPath( ) set in the playlist file. In a configuration in which audio (1) for Japanese language and audio (2) for English language are set, for example, when the audio (2) for English language is deleted as non-copy target, the subpath used as designation information of the audio stream of the audio (2) for English language is deleted.

As such, when the playlist file recorded on the first medium as the copy source ((1) playlist before updating shown in FIG. 30) is copied onto the second medium and there is the clip AV stream corresponding to the deleted subpath, the subpath information (SubPath( )) used as designation information of the deleted clip AV stream is deleted.

With the deletion process, (2) playlist after updating shown in FIG. 30 is created. The updated playlist file is recorded onto the second medium as the copy destination.

FIG. 31 is a diagram showing an example of a clip information file updating process. The clip information file is a file recorded with reproduction information corresponding to the clip AV stream that is reproduction target data, or the like, and a process is performed to change the data into recorded data according to clip AV stream data after a data deletion process and a conversion process.

Specifically, the data change is performed as shown in FIG. 31. In other words:

TS_recording_rate: To change to bit-rate after data conversion (transcoding);

number_of_source_packets: To change to the total number of packets after data conversion (transcoding);

ProgramInfo( ): To perform a change process is performed in accordance with stream information included in the transport stream (TS) after data conversion (transcoding);

number_of_stream_in_ps: To change to the number of streams after data conversion (transcoding);

PID and StreamCodingInfo( ): To change to information according to the stream after data conversion (transcoding) and to delete information of the deleted stream; and

SPN of EP map: To change to a packet number after data conversion (transcoding).

The clip information file updating process accompanied by those change processes is executed.

The process is performed as a process of Step S173 of the flow shown in FIG. 29, that is, an updating process of the playlist file and the clip information file.

With the updating process, a playlist file and a clip information file coinciding with the content of the AV stream file copied and recorded onto the second medium are created.

The process is executed as a process of Step S153 shown in FIG. 28, and after the completion of the process, a process of Step S154 shown in FIG. 28 is executed.

In Step S154, the following data is recorded on the second medium that is the copy destination medium, which includes:

updated playlist file (PlayList);

updated clip information file (ClipInfo); and

clip AV stream data of which a picture of an angle change point is set as an IDR picture or an I-picture of a closed GOP.

The data recorded on the second medium with the above process becomes data in a different form from the data recorded on the first medium, but becomes copied content of which a angle change process can be assuredly performed as the same process as for the copy source content.

In other words, PTS/SPN data of the angle change point has a correct setting corresponding to a configuration of the clip AV stream after conversion in the registration information of the EP map recorded in the clip information file.

In addition, the leading picture of the angle change point in the clip AV stream is set as the leading I-picture of the closed GOP or an IDR picture, and set as a picture that can be subjected to smooth decoding and reproduction.

### [7. Regarding Configuration Example of Information Processing Apparatus]

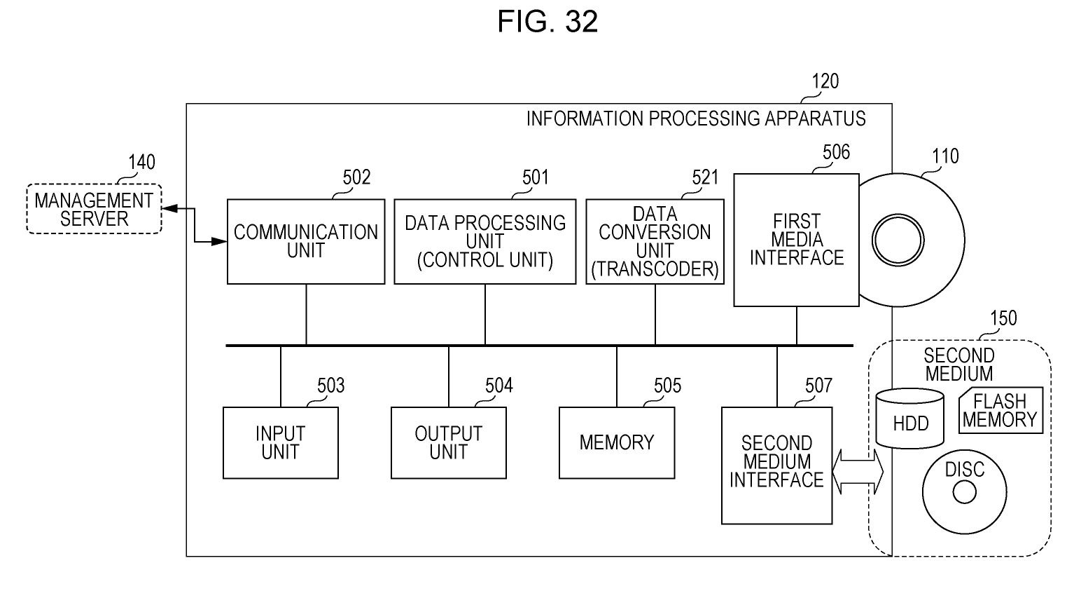

Finally, a configuration example of the information processing apparatus 120 according to an embodiment of the present disclosure will be described with reference to FIG. 32. The information processing apparatus 120 is configured to load the first medium 110 that is a recording medium of copy source content and the second medium 150 as a copy destination of the content therein. Furthermore, it is not necessary to be able to load only two media, but a copy destination medium may be configured to be loaded in another apparatus connected via a USB cable, wireless communication, or the like to output copied data.

As the first medium 110 and the second medium 150, various media (information recording media) including, for example, B1u-ray (registered trademark) discs, DVDs, hard disks, flash memories, and the like can be used.

The information processing apparatus 120 includes a data processing unit (control unit) 501, a communication unit 502, an input unit 503, an output unit 504, a memory 505, a first media interface 506, a second media interface 507, and a data conversion unit (transcoder) 521.

The data processing unit 501 is constituted by a CPU having a program execution function for executing a processing program for various data, or the like. For example, in addition to a data recording and reproduction process, various processes accompanying a copy process according to the above-described flowcharts are executed. Furthermore, the data processing unit controls general processes executed by the apparatus including a communication process between the management server 140 via the communication unit 102.

The data conversion unit (transcoder) 521 executes a data conversion process in a copy process.

For example, as previously described with reference to FIG. 22, the data conversion unit executes a conversion process accompanying the following processes:

(1) Conversion of encoding format (conversion between MPEG-2 and AVC formats or the like);

(2) Conversion of video compression rate; and

(3) Elimination of stream.

The communication unit 502 is used in a communication process between the management server 140 to perform request and reception of server response information (Offer Response) described above, and further used in a payment process, a reception process of copy permission information (Permission), or the like.

The input unit 503 is an operation unit of a user, for example, and performs various inputs including an input of instruction of data recording or reproduction, an input of copying instruction, or the like. Furthermore, a remote controller is included in the input unit 503, and information of remote controller operation can also be input. The output unit 504 is an output part of audio and images, which includes a display, a speaker or the like. The memory 505 includes a RAM, a ROM, or the like, and is used as a storage area for a program executed in the data processing unit 501, various parameters, and received data, or the like, and further used also as a buffer area of copied data.

The first media interface 506 is an interface applied to data recording, reproduction, and a copy process using the first medium 110. The first media interface performs processes of data writing, data reading, data copying or the like using the first medium 110 according to requests from the data processing unit 501.

The second media interface 507 is an interface applied to data recording, reproduction, and a copy process using the second medium 150. The second media interface performs processes of data writing, data reading, data copying or the like using the second medium 150 according to requests from the data processing unit 501.

Hereinabove, the present disclosure has been discussed with reference to a specific embodiment. However, it is clear that a person skilled in the art can accomplish modification or substitution of the embodiment without departing from the gist of the disclosure. In other words, the disclosure is disclosed in a form for exemplification, and is not supposed to be interpreted in a limited manner. In order to determine the gist of the disclosure, the claims for the disclosure should to be taken into consideration.

In addition, the series of processes described in the present specification can be executed in hardware, software, or a combined configuration of both. In the case of executing a process in software, a program recorded with a process sequence can be executed after being installed in a memory of a computer which has dedicated hardware incorporated, or can be executed by installing a program on a general-purpose computer that can execute various processes. For example, the program can be recorded on a recording medium in advance. In addition to the installation of the program in a computer from a recording medium, the program can be received via a network such as a LAN (Local Area Network), or the Internet, and can be installed on a recording medium such as a hard disk, or the like, built therein.

Furthermore, various processes described in the present specification are executed not only in a time series according to the description but also in parallel or individually according to the processing capability of a device used to execute the processes or to necessity. In addition, the system in the present specification employs a logically aggregated configuration of a plurality of devices, and the devices of each configuration are not in the same case at all times.

The present disclosure contains subject matter related to that disclosed in Japanese Priority Patent Application JP 2010-155697 filed in the Japan Patent Office on Jul. 8, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a data processing unit which executes control of a copy process in which data recorded on a first medium is recorded on a second medium; and
a data conversion unit which executes data conversion in the copy process,
wherein the data processing unit determines whether or not data to be copied recorded on the first medium is multi-angle content for which an angle change process is permitted, and when the data to be copied is determined to be multi-angle content, angle change point information is acquired and provided to the data conversion unit, and
wherein the data conversion unit creates converted data for which decoding is possible without referring to at least a preceding picture when the picture on an angle change point location is reproduced as a reproduction start point.

2. The information processing apparatus according to claim 1, wherein, when the picture of the angle change point is an I-picture of a closed GOP, the data conversion unit creates the converted data maintaining the I-picture of the angle change point as an I-picture of a closed GOP even in the data after conversion.

3. The information processing apparatus according to claim 1, wherein, when the picture of the angle change point is an I-picture of a closed GOP and the data after conversion is AVC formatted data, the data conversion unit performs a process of converting the I-picture of the angle change point into an IDR (Instantaneous Decoder Refresh) picture defined in an AVC format.

4. The information processing apparatus according to claim 1, wherein, when the picture of the angle change point is the IDR (Instantaneous Decoder Refresh) picture defined in the AVC format, the data conversion unit creates the converted data maintaining the IDR picture of the angle change point as the IDR picture even in the data after conversion.

5. The information processing apparatus according to claim 1, wherein the data processing unit executes a process of determining whether or not the data to be copied is multi-angle content with reference to recording information of a playlist file or a clip information file that are control information files of the data to be copied that is recorded on the first medium.

6. The information processing apparatus according to claim 1, wherein the data processing unit determines whether or not stream data designated by each playitem is data for multi-angle in a unit of playitem information of the playlist file that is a control information file of the copy target data recorded on the first medium.

7. The information processing apparatus according to claim 1, wherein the data conversion unit creates the converted data by setting the leading picture included in a packet stipulated in a source packet number (SPN) which is recorded in an EP map of the clip information file that is a control information file of the copy target data recorded on the first medium and indicates the packet location of an angle change point to the leading I-picture of a closed GOP or an IDR picture.

8. The information processing apparatus according to claim 1, wherein the data conversion unit executes a data conversion process including at least any process of conversion of an encoding format, conversion of a compression rate, or deletion of a stream.

9. The information processing apparatus according to claim 1, further comprising:
a communication unit which executes communication with a management server,
wherein the data processing unit displays a list of copy permitted data included in the data recorded on the first medium based on information received from the management server, and selects the data to be copied based on user designation for displayed information.

10. An information processing method executed by an information processing apparatus, comprising:
data-processing by a data processing unit to execute control of a copy process in which data recorded on a first medium is recorded on a second medium; and
data-converting by a data conversion unit to execute data conversion in the copy process,
wherein, in the data processing, it is determined whether or not data to be copied recorded on the first medium is multi-angle content for which an angle change process is permitted, and when the data to be copied is determined to be multi-angle content, angle change point information is acquired and provided to the data conversion unit, and
wherein the data converting is creating converted data for which decoding is possible without referring to at least a preceding picture when the picture on an angle change point location is reproduced as a reproduction start point.

11. A program which causes an information processing apparatus to execute an information process, comprising:
data-processing for causing a data processing unit to execute control of a copy process in which data recorded on a first medium is recorded on a second medium; and
data-converting for causing a data conversion unit to execute data conversion in the copy process,
wherein, in the data processing, it is caused to determine whether or not data to be copied recorded on the first medium is multi-angle content for which an angle change process is permitted, and when the data to be copied is determined to be multi-angle content, angle change point information is caused to be acquired and provided to the data conversion unit, and
wherein, in the data converting, converted data is caused to be created for which decoding is possible without referring to at least a preceding picture when the picture on an angle change point location is reproduced as a reproduction start point.
